(19) United States
(12) Patent Application Publication
(10) Pub. No.: US 2010/0287332 A1
(43) Pub. Date: Nov. 11, 2010

(54) DATA STORING SYSTEM, DATA STORING METHOD, EXECUTING DEVICE, CONTROL METHOD THEREOF, CONTROL DEVICE, AND CONTROL METHOD THEREOF

(76) Inventors: Junichi Koshiyama, Tokyo (JP); Kenichi Nakanishi, Tokyo (JP); Keiichi Tsutsui, Tokyo (JP)

Correspondence Address: FROMMER LAWRENCE & HAUG LLP, 745 FIFTH AVENUE, NEW YORK, NY, 10151, US

(21) Appl. No.: 12/771,300

(22) Filed: Apr. 30, 2010

(30) Foreign Application Priority Data
May 8, 2009 (JP) P2009-113414

(51) Int. Cl. G06F 12/00; G06F 12/02

(52) U.S. Cl. 711/103; 711/157; 711/E12.001; 711/E12.008; 711/E12.079

(57) ABSTRACT

A data storing system including: a non-volatile memory configured to have a plurality of memory blocks each capable of independently operating and allow random access to each of addresses; a controller configured to control writing of data to the non-volatile memory; and an executing unit configured to execute a predetermined application, wherein the executing unit decides the number of interleaves indicating the number of memory blocks operated in parallel among the plurality of memory blocks, and the executing unit notifies the controller of the decided number of interleaves.

### BACKGROUND OF THE INVENTION

1. Field of the Invention

The present invention relates to data storing systems, data storing methods, executing devices, control methods thereof, control devices, and control methods thereof, and particularly to a data storing system, a data storing method, an executing device, a control method thereof, a control device, and a control method thereof each having flexibility in the memory control and each allowing improvement in the speed of processing of writing data.

2. Description of the Related Art

The FeRAM, the PCRAM, and the ReRAM are being researched and developed and being productized as the non-volatile memory (non-volatile random access memory (RAM) (NVRAM)) that can hold data even after the power supply thereto is cut off although allowing random access like the SRAM and the DRAM, which are the volatile memory (RAM).

These non-volatile memories are expected to replace the SRAM and the DRAM in the future. Furthermore, new applications thereof are being sought because of the characteristic that they are non-volatile although allowing random access.

Among the non-volatile memories are memories of such a type that, in data rewriting, new data cannot be written until processing of erasing data already stored is executed. When a non-volatile memory of such a type is used, if merely simple operation of executing processing of erasing data and then executing processing of writing data is carried out, the time necessary for the processing of erasing data often appears as an overhead.

Furthermore, in the memory allowing random access, data writing is carried out in various units depending on the application, e.g. in various units in the range from a small size such as one byte or several bytes to a large size such as several kilobytes. In the NAND flash memory, which is used for various purposes such as the storage and the cache in recent years, the electrically-conductive line necessary for the cell driving is shared by plural cells, and therefore writing is carried out in units called the page, which is fixed depending on the device (in units of 512 bytes, two Kbytes, or four Kbytes).

Therefore, although the processing is executed at high speed for writing in units of the page, the writing performance becomes lower when the unit of the writing is smaller. In order to address such lowering of the writing performance and so on, various methods for the memory control have been proposed as the related arts.

For example, JP-T-2008-535139 discloses a method in which the next writing data is cached in a data latch in parallel to processing of erasing data to thereby improve the writing performance. In such a method, the appearance of an overhead due to the erasing time is avoided if the time it takes to execute the processing of caching data of the writing unit in the data latch is substantially equal to the time for the data erasing. However, the writing unit is not taken into consideration. Therefore, if the writing is carried out in various units depending on the application, the erasing time is often longer than the time it takes to cache the writing data in the data latch. In this case, an overhead due to the erasing time significantly appears.

As another related art, Japanese Patent Laid-Open No. 2003-122630 discloses a method in which banks in a non-volatile memory for logical addresses are assigned from a host. However, in such a method, the memory controller does not know the writing unit from the host, and therefore it is impossible that the logical addresses in the host are assigned to banks in the non-volatile memory in such a way that the writing speed is enhanced.

### SUMMARY OF THE INVENTION

As described above, in the related arts, the time required for data writing is often long because of the appearance of an overhead due to the erasing time.

Therefore, it is required to improve the speed of processing of writing data.

There is a need for the present invention to provide flexibility in the memory control and allow improvement in the speed of processing of writing data.

According to a first embodiment of the present invention, there is provided a data storing system including a non-volatile memory configured to have a plurality of memory blocks each capable of independently operating and allow random access to each of addresses, a controller configured to control writing of data to the non-volatile memory, and an executing unit configured to execute a predetermined application. In the data storing system, the executing unit decides the number of interleaves indicating the number of memory blocks operated in parallel among the plurality of memory blocks, and the executing unit notifies the controller of the decided number of interleaves.

According to the first embodiment of the present invention, there is provided a data storing method of a data storing system including a non-volatile memory that has a plurality of memory blocks each capable of independently operating and allows random access to each of addresses, a controller that controls writing of data to the non-volatile memory, and an executing unit that executes a predetermined application. The data storing method includes the steps of deciding the number of interleaves indicating the number of memory blocks operated in parallel among the plurality of memory blocks, and notifying the controller of the decided number of interleaves.

In the first embodiment of the present invention, the number of interleaves indicating the number of memory blocks operated in parallel is decided, and the number of interleaves is notified.

According to a second embodiment of the present invention, there is provided an executing device that executes a predetermined application. The executing device includes a deciding unit configured to decide the number of interleaves indicating the number of memory blocks operated in parallel among a plurality of memory blocks each capable of independently operating in a non-volatile memory that has the plurality of memory blocks and allows random access to each of addresses, and a notifying unit configured to notify the decided number of interleaves to a controller that controls writing of data to the non-volatile memory.

According to the second embodiment of the present invention, there is provided a control method of an executing device that executes a predetermined application. The control method includes the steps of deciding the number of interleaves indicating the number of memory blocks operated in parallel among a plurality of memory blocks each capable of independently operating in a non-volatile memory that has the plurality of memory blocks and allows random access to each of addresses, and notifying the decided number of interleaves to a controller that controls writing of data to the non-volatile memory.

In the second embodiment of the present invention, the number of interleaves indicating the number of memory blocks operated in parallel in the non-volatile memory that has the plurality of memory blocks each capable of independently operating and allows random access to each of addresses is decided, and the number of interleaves is notified to the controller that controls writing of data to the non-volatile memory.

According to a third embodiment of the present invention, there is provided a control device that controls writing of data to a non-volatile memory that has a plurality of memory blocks each capable of independently operating and allows random access to each of addresses. The control device includes a setting unit configured to save an address space used by a predetermined application executed by an executing unit, an access unit set in the application, and the number of interleaves indicating the number of memory blocks operated in parallel among the plurality of memory blocks. The address space, the access unit, and the number of interleaves are notified from the executing unit. The control device further includes an assigning unit configured to assign the address space in the executing unit to addresses in the non-volatile memory based on the address space, the access unit, and the number of interleaves saved in the setting unit.

According to the third embodiment of the present invention, there is provided a control method of a control device that controls writing of data to a non-volatile memory that has a plurality of memory blocks each capable of independently operating and allows random access to each of addresses. The control method includes the step of saving an address space used by a predetermined application executed by an executing unit, an access unit set in the application, and the number of interleaves indicating the number of memory blocks operated in parallel among the plurality of memory blocks. The address space, the access unit, and the number of interleaves are notified from the executing unit. The control method further includes the step of assigning the address space in the executing unit to addresses in the non-volatile memory based on the address space, the access unit, and the number of interleaves that are saved.

In the third embodiment of the present invention, the address space used by the predetermined application executed by the executing unit, the access unit set in the application, and the number of interleaves indicating the number of memory blocks operated in parallel are saved. The address space, the access unit, and the number of interleaves are notified from the executing unit. Based on the address space, the access unit, and the number of interleaves, the address space in the executing unit is assigned to addresses in the non-volatile memory.

The first to third embodiments of the present invention provide flexibility in the memory control and allow improvement in the speed of processing of writing data.

### BRIEF DESCRIPTION OF THE DRAWINGS

FIG. 1 is a block diagram showing a configuration example of a data storing system according to one embodiment of the present invention;

FIG. 2 is a diagram for explaining a first conversion example for converting addresses;

FIG. 3 is a diagram for explaining a second conversion example for converting addresses;

FIG. 4 is a diagram for explaining a third conversion example for converting addresses;

FIG. 5 is a diagram for explaining the balance between the erasing time and the writing time when the access unit is set to 16 bytes and the number of interleaves is set to eight;

FIG. 6 is a diagram for explaining the balance between the erasing time and the writing time when the access unit is set to 16 bytes and the number of interleaves is set to eight;

FIG. 7 is a diagram for explaining the balance between the erasing time and the writing time when the access unit is set to 16 bytes and the number of interleaves is set to four;

FIG. 8 is a diagram for explaining the balance between the erasing time and the writing time when the access unit is set to 16 bytes and the number of interleaves is set to four;

FIG. 9 is a diagram for explaining the balance between the erasing time and the writing time when the access unit is set to 16 bytes and the number of interleaves is set to two;

FIG. 10 is a diagram for explaining the balance between the erasing time and the writing time when the access unit is set to 16 bytes and the number of interleaves is set to two;

FIG. 11 is a diagram for explaining the balance between the erasing time and the writing time when the access unit is set to 16 bytes and the number of interleaves is set to four;

FIG. 12 is a diagram for explaining the balance between the erasing time and the writing time when the access unit is set to 16 bytes and the number of interleaves is set to four;

FIG. 13 is a diagram for explaining the balance between the erasing time and the writing time when the access unit is set to 16 bytes and the number of interleaves is set to two;

FIG. 14 is a diagram for explaining the balance between the erasing time and the writing time when the access unit is set to 16 bytes and the number of interleaves is set to two;

FIG. 15 is a diagram for explaining the balance between the erasing time and the writing time in erasing of data of plural bytes;

FIG. 16 is a diagram for explaining the balance between the erasing time and the writing time in erasing of data of plural bytes;

FIG. 17 is a flowchart for explaining processing of deciding the number of interleaves;

FIG. 18 is a flowchart for explaining processing of making setting for a memory controller;

FIG. 19 is a flowchart for explaining processing of converting addresses;

FIG. 20 is a flowchart for explaining processing of writing data to a non-volatile memory;

FIG. 21 is a timing chart when erasing-ahead memory control is carried out;

FIG. 22 is a timing chart when the erasing-ahead memory control is not carried out;

FIG. 23 is a flowchart for explaining processing of writing data to the non-volatile memory by carrying out the erasing-ahead memory control;

FIG. 24 is a block diagram showing a configuration example of a data storing system according to another embodiment of the present invention; and

FIG. 25 is a block diagram shoving a configuration example of a computer.

### DETAILED DESCRIPTION OF THE PREFERRED EMBODIMENTS

Specific embodiments of the present invention will be described in detail below with reference to the drawings.

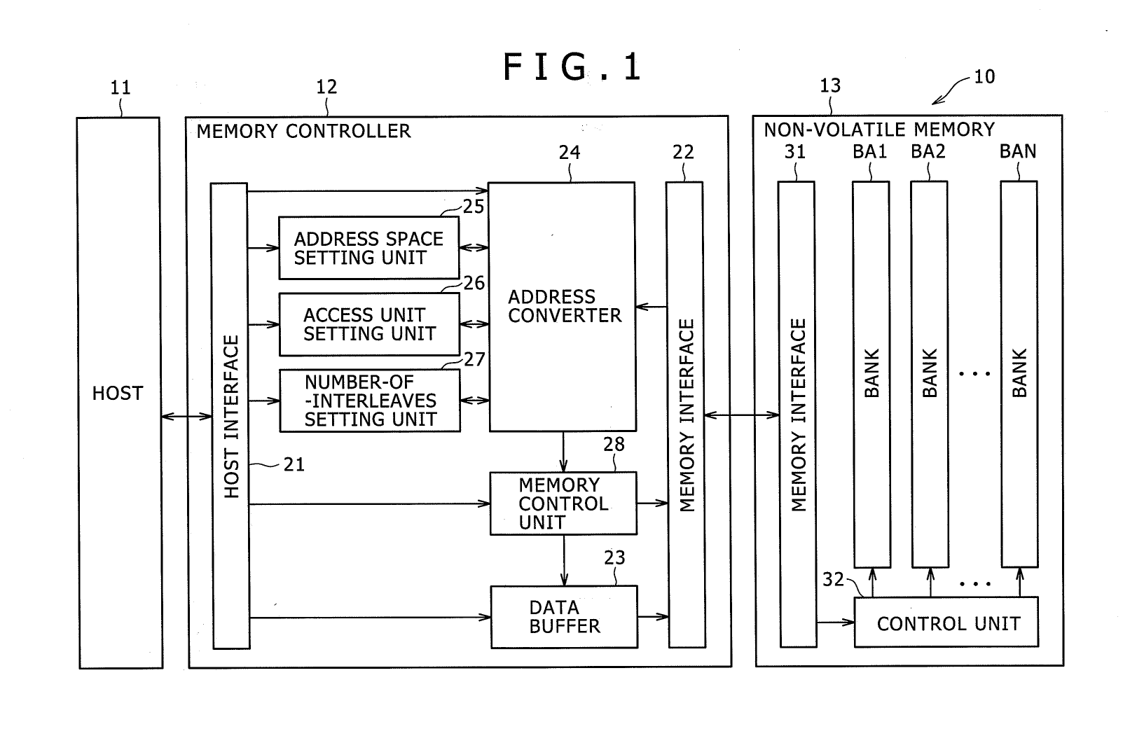

FIG. 1 is a block diagram showing a configuration example of a data storing system according to one embodiment of the present invention. In the present specification, the term “system” refers to the whole of a device composed of plural devices.

In FIG. 1, a data storing system 10 includes a host 11, a memory controller 12, and a non-volatile memory 13. The non-volatile memory 13 is a memory of such a type that, in processing of data writing, a series of processing of erasing data and then writing data is necessary.

The host 11 executes a predetermined host application, and issues, to the memory controller 12, a request to write data to the non-volatile memory 13 and a request to read out data from the non-volatile memory 13 according to need.

Furthermore, the host 11 transfers data in predetermined access units of one byte or several bytes and writes the data to the non-volatile memory 13. This access unit is decided depending on the way of use of the memory by the host application executed by the host 11. For example, when starting the execution of the host application, the host 11 notifies the memory controller 12 of the access unit decided depending on the host application.

In the host 11, for each of the host applications executed by the host 11, the address space used in the application is set. The host 11 notifies the memory controller 12 of the address space in the host 11.

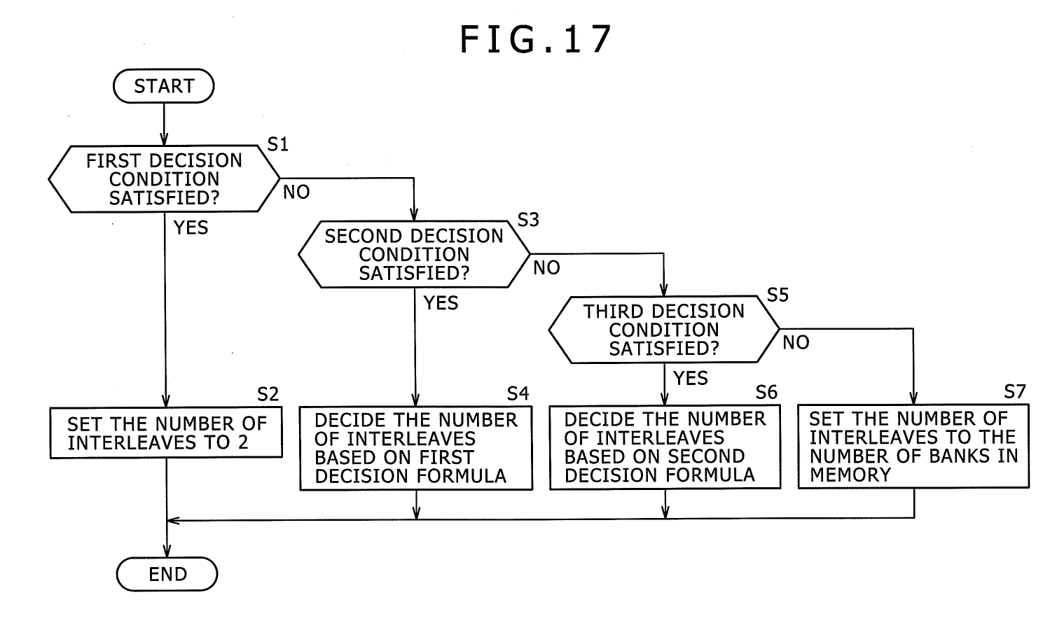

Moreover, the host 11 decides the number of interleaves, indicating the number of banks (memory blocks) operated in parallel in the non-volatile memory 13, depending on the specifications of the host application, the use environment of the data storing system 10, and so on, and notifies the memory controller 12 of the number of interleaves. For example, the host 11 decides the number of interleaves used when the memory control is carried out with priority to the processing speed as described later with reference to FIG. 17.

The memory controller 12 includes a host interface 21, a memory interface 22, a data buffer 23, an address converter 24, an address space setting unit 25, an access unit setting unit 26, a number-of-interleaves setting unit 27, and a memory control unit 28.

The host interface 21 mediates signals between the host 11 and the memory controller 12, and the memory interface 22 mediates signals between the memory controller 12 and the non-volatile memory 13.

The address space setting unit 25 is notified of the address space in the host 11 (i.e. is supplied with information indicating the address space) via the host interface 21, and the address space setting unit 25 stores the address space in the host 11 in a register. The address space in the host 11 is set for each of the host applications executed by the host 11, and the address space setting unit 25 stores the address spaces in the host 11, set on each host application basis.

The access unit setting unit 26 is notified of the access unit from the host 11 (i.e. is supplied with information indicating the access unit) via the host interface 21, and the access unit setting unit 26 stores the access unit from the host 11 in a register.

The number-of-interleaves setting unit 27 is notified of the number of interleaves decided by the host 11 (i.e. is supplied with information indicating the number of interleaves) via the host interface 21, and the number-of-interleaves setting unit 27 stores the number of interleaves in a register.

Data to be stored in the non-volatile memory 13 are supplied from the host 11 to the data buffer 23 via the host interface 21, and the data buffer 23 buffers the data.

The address converter 24 converts (assigns) the address space in the host 11, set in the address space setting unit 25, to addresses in the non-volatile memory 13 based on the access unit set in the access unit setting unit 26 and the number of interleaves set in the number-of-interleaves setting unit 27. The number of interleaves refers to the number of banks operated in parallel with switching of the banks, among banks BA1 to BAN in the non-volatile memory 13.

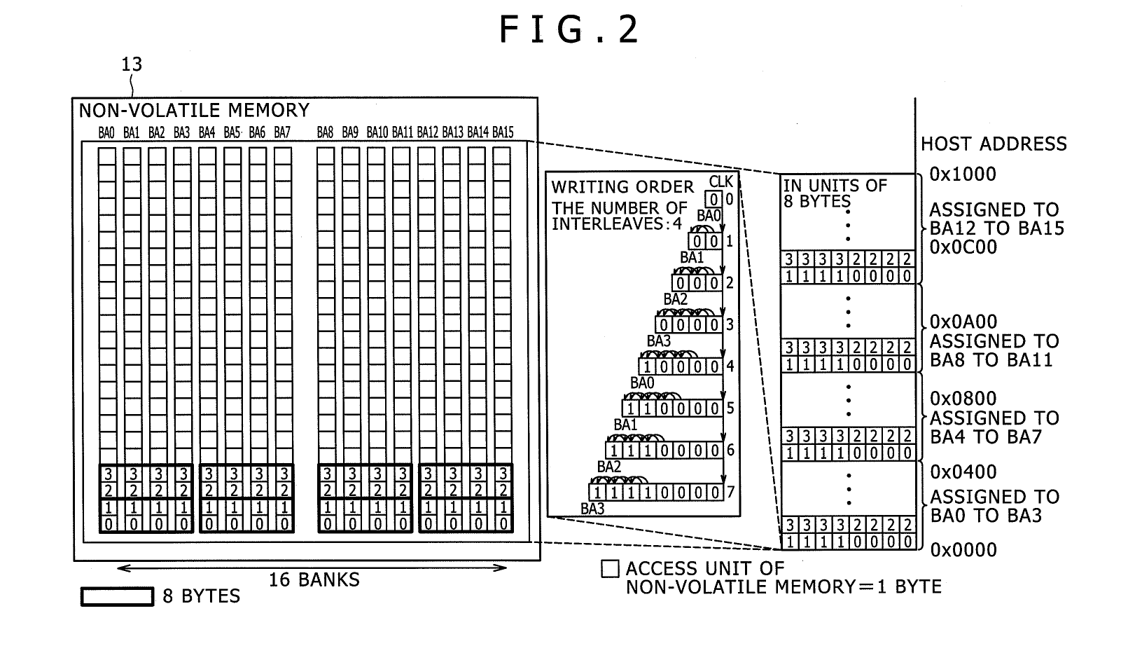

For example, as described later with reference to FIGS. 2 to 4, sequentially from the lower-level address in the host 11, the address converter 24 assigns the address space in the host 11 to the banks BA1 to BAN in the non-volatile memory 13 in the writing units sequentially from the lower-level row in the beginning bank. Specifically, the address converter 24 assigns the address space in the host 11 to addresses in the non-volatile memory 13 in such a way that banks in the non-volatile memory 13 are interleaved (switched) and the operation of returning to the row of the next writing unit in the beginning bank when the interleaving is carried out for the same number of banks as the number of interleaves is repeated.

Furthermore, for example, the address converter 24 stores, in a register, an address conversion table in which the address space in the host 11 is associated with the addresses in the non-volatile memory 13.

The memory control unit 28 controls writing of data supplied from the host 11 via the host interface 21 to the non-volatile memory 13 via the memory interface 22.

From the host 11, together with a command (writing command) instructing the non-volatile memory 13 to write data thereto, the data to be written to the non-volatile memory 13 and the addresses of the data in the host 11 are transmitted. In accordance with the writing command, the memory control unit 28 refers to the address conversion table in the address converter 24 and converts the addresses of the data to be written to the non-volatile memory 13 in the host 11 to addresses in the non-volatile memory 13.

Furthermore, the memory control unit 28 carries out control to write, to the non-volatile memory 13, the data that are associated with the addresses in the host 11, converted to the addresses in the non-volatile memory 13, and are buffered in the data buffer 23 (hereinafter, the data will be accordingly referred to also as the data corresponding to the addresses obtained by the conversion). Specifically, in synchronization with a predetermined operating clock, the memory control unit 28 makes the data be output to the non-volatile memory 13 and supplies the writing command and the addresses in the non-volatile memory 13 obtained by the conversion to a control unit 32 via the memory interface 22 and a memory interface 31. The writing command transmitted from the memory control unit 28 to the non-volatile memory 13 is to carry out a series of operation of erasing data at the specified addresses and then writing data to these addresses.

Furthermore, the memory control unit 28 ensures, in the non-volatile memory 13, the area for storing the address space stored in the address space setting unit 25, the access unit stored in the access unit setting unit 26, and the number of interleaves stored in the number-of-interleaves setting unit 27. At the time of the system stop of the data storing system 10, the memory control unit 28 makes the non-volatile memory 13 store the address space, the access unit, and the number of interleaves as setting information. Moreover, at the time of activation of the data storing system 10, the memory control unit 28 can read out the setting information stored in the non-volatile memory 13 from the non-volatile memory 13, and can set the information in the address space setting unit 25, the access unit setting unit 26, and the number-of-interleaves setting unit 27.

The non-volatile memory 13 includes the memory interface 31, the control unit 32, and N banks BA1 to BAN.

The memory interface 31 mediates signals between the memory controller 12 and the non-volatile memory 13.

When the control unit 32 is supplied with the data to be written to the non-volatile memory 13 and the addresses of the data together with the writing command from the memory controller 12 via the memory interface 31, the control unit 32 temporarily accumulates the data and starts to erase the data at the addresses. Upon completing the erasing of the data at the addresses, the control unit 32 executes continuous processing of writing the data to the addresses.

As described above, the addresses are so assigned that writing is carried out in the writing units with interleaving of banks in the non-volatile memory 13 and the operation of returning to the row of the next writing unit in the beginning bank when the interleaving is carried out for the same number of banks as the number of interleaves is repeated. Thus, the control unit 32 can write the data to each of the banks BA1 to BAN with interleaving of the banks BA1 to BAN.

The banks BA1 to BAN are segments (memory blocks) arising from partitioning of the storage area of the non-volatile memory 13, and are each capable of independently operating. Furthermore, the banks BA1 to BAN are so configured that writing or erasing is carried out in units of a predetermined number of bytes. For example, writing or erasing in units of one byte or four bytes is possible.

In the data storing system 10 having the above-described configuration, the host 11 notifies the memory controller 12 of the access unit and the number of interleaves. In the memory controller 12, the address space in the host 11 is assigned to addresses in the non-volatile memory 13 in accordance with the access unit and the number of interleaves. When a request for writing to the non-volatile memory 13 is issued from the host 11, the memory controller 12 converts the addresses in the host 11 to the addresses in the non-volatile memory 13. In the non-volatile memory 13, data erasing operation and data writing operation are carried out in parallel with interleaving of the banks BA1 to BAN.

With reference to FIGS. 2 to 4, conversion examples for converting addresses in accordance with the setting of the access unit and the number of interleaves will be described below. The method for converting addresses is not limited to three methods described below.

FIG. 2 shows a first conversion example in which the access unit from the host 11 and the number of interleaves are set to eight bytes and four, respectively, for the non-volatile memory 13 including 16 banks BA0 to BA15 capable of independently operating. Suppose that the non-volatile memory 13 of FIG. 2 allows data writing in units of one byte and data erasing in units of one byte.

When the access unit and the number of interleaves are set in this manner, initially the address space in the host 11 is assigned to the banks BA0 to BA3 in the non-volatile memory 13 sequentially from the least significant address (0x0000) in the address space in the host 11 toward the higher-level address.

For example, eight bytes of the least significant address are assigned to eight bytes on the 0-th row and the first row in the banks BA0 to BA3 (the area surrounded by the heavy line), and eight bytes of the next address are assigned to eight bytes on the second row and the third row in the banks BA0 to BA3. Also for the subsequent addresses, the address space in the host 11 is similarly assigned to the banks BA0 to BA3 in the non-volatile memory 13 sequentially toward the higher-level address.

When the assignment to all of the banks BA0 to BA3 in the non-volatile memory 13 is completed, the next addresses in the address space in the host 11 are assigned to the banks BA4 to BA7 in the non-volatile memory 13. Specifically, eight bytes of the address subsequent to the last address assigned to the banks BA0 to BA3 in the non-volatile memory 13 are assigned to eight bytes on the 0-th row and the first row in the banks BA4 to BA7. Furthermore, eight bytes of the next address are assigned to eight bytes on the second row and the third row in the banks BA4 to BA7. Also for the subsequent addresses, the address space in the host 11 is similarly assigned to the banks BA4 to BA7 in the non-volatile memory 13 sequentially toward the higher-level address.

When the assignment to all of the banks BA4 to BA7 in the non-volatile memory 13 is completed, the next addresses in the address space in the host 11 are assigned to the banks BA8 to BA11 in the non-volatile memory 13. Moreover, when the assignment to all of the banks BA8 to BA11 in the non-volatile memory 13 is completed, the next addresses in the address space in the host 11 are assigned to the banks BA12 to BA15 in the non-volatile memory 13.

Because the address space in the host 11 is assigned to the non-volatile memory 13 in this manner, data writing with interleaving of the banks is carried out in the non-volatile memory 13 when a request for writing from the host 11 is issued.

For example, when a request for writing of the data of eight bytes of the least significant address (0x0000) in the host 11 is issued, data writing to the 0-th row in the bank BA0 in the non-volatile memory 13 is started. Furthermore, with interleaving of banks, data writing to the 0-th row in the bank BA1, the 0-th row in the bank BA2, and the 0-th row in the bank BA3 is sequentially started. Subsequently to the data writing to the 0-th row in the bank BA3, data writing to the first row in the bank BA0 is started. For the subsequent data, data writing to the first row in the bank BA1, the first row in the bank BA2, and the first row in the bank BA3 is sequentially started similarly.

By carrying out the data writing with interleaving of banks in this manner, the data writing can be carried out in such a way that the data erasing time is hidden.

Specifically, as described above, a series of processing of erasing data and then writing data is execute in accordance with the data writing command in the non-volatile memory 13. At this time, if such interleaving that the erasing time can be hidden by the writing time is set by the host 11, an overhead due to the erasing time is hidden and the number of banks that simultaneously operate can be set small.

For example, the case in which the time necessary for erasing and writing in the non-volatile memory 13 is equivalent to four clocks of the operating clock will be described below by taking as an example the writing of the data of eight bytes of the least significant address (0x0000) in the host 11.

In this case, as shown by the writing order in FIG. 2, processing of writing data to the 0-th row in the bank BA0 is started in synchronization with a clock CLK0. In synchronization with a clock CLK1, processing of writing data to the 0-th row in the bank BA1 is started through bank interleaving. For the subsequent data, similarly, processing of writing data to the 0-th row in the bank BA2 is started in synchronization with a clock CLK2, and processing of writing data to the 0-th row in the bank BA3 is started in synchronization with a clock CLK3.

Because the time necessary for erasing and writing in the non-volatile memory 13 is equivalent to four clocks of the operating clock, the data writing to the 0-th row in the bank BA0, started in synchronization with the clock CLK0, has been completed at the start of a clock CLK4. Therefore, in synchronization with the clock CLK4, processing of writing data to the first row in the bank BA0 can be started. For the subsequent data, similarly, processing of writing data to the first row in the bank BA1 is started in synchronization with a clock CLK5, processing of writing data to the first row in the bank BA2 is started in synchronization with a clock CLK6, and processing of writing data to the first row in the bank BA3 is started in synchronization with a clock CLK7.

By interleaving the banks in this manner, the writing is continuously carried out in such a way that the data erasing operation is hidden from the viewpoint of the host 11.

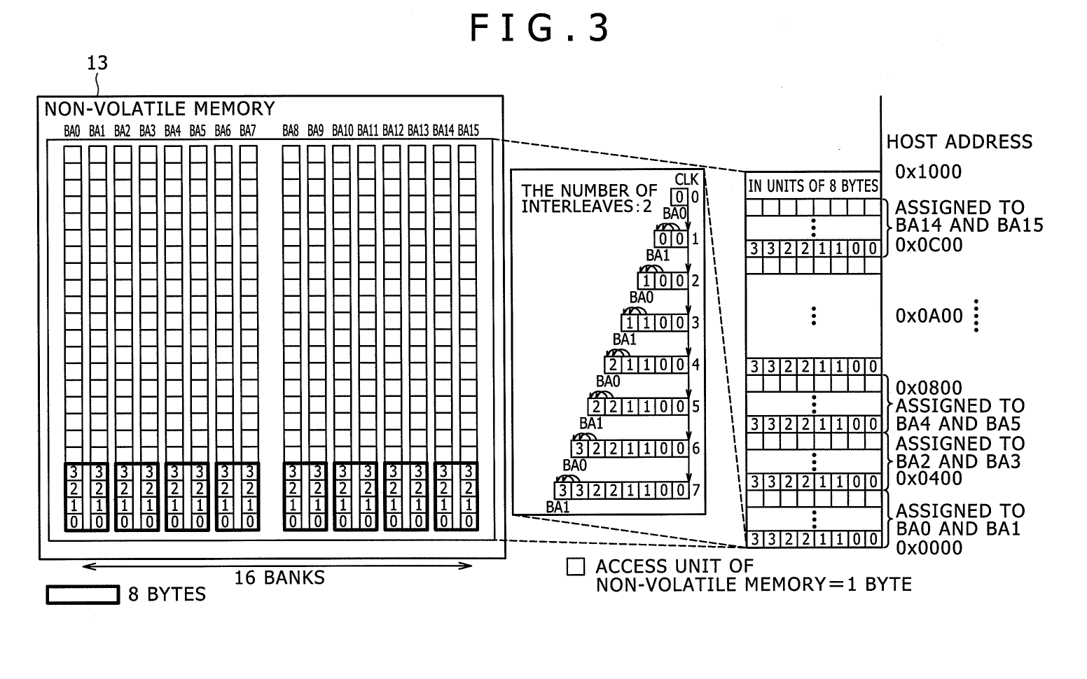

FIG. 3 shows a second conversion example in which the access unit from the host 11 and the number of interleaves are set to eight bytes and two, respectively, for the non-volatile memory 13 including 16 banks BA0 to BA15 capable of independently operating. Suppose that the non-volatile memory 13 of FIG. 3 allows data writing in units of one byte and data erasing in units of four bytes.

When the access unit and the number of interleaves are set in this manner, initially the address space in the host 11 is assigned to the banks BA0 and BA1 in the non-volatile memory 13 sequentially from the least significant address (0x0000) in the address space in the host 11 toward the higher-level address.

For example, eight bytes of the least significant address are assigned to eight bytes on the rows from the 0-th row to the third row in the banks BA0 and BA1 (the area surrounded by the heavy line), and eight bytes of the next address are assigned to eight bytes on the rows from the fourth row to the seventh row in the banks BA0 and BA1. Also for the subsequent addresses, the address space in the host 11 is similarly assigned to the banks BA0 and BA1 in the non-volatile memory 13 sequentially toward the higher-level address.

When the assignment to all of the banks BA0 and BA1 in the non-volatile memory 13 is completed, the next addresses in the address space in the host 11 are assigned to the banks BA2 and BA3 in the non-volatile memory 13. Specifically, eight bytes of the address subsequent to the last address assigned to the banks BA0 and BA1 in the non-volatile memory 13 are assigned to eight bytes on the rows from the 0-th row to the third row in the banks BA2 and BA3. Furthermore, eight bytes of the next address are assigned to eight bytes on the rows from the fourth row to the seventh row in the banks BA2 and BA3. Also for the subsequent addresses, the address space in the host 11 is similarly assigned to the banks BA2 and BA3 in the non-volatile memory 13 sequentially toward the higher-level address.

When the assignment to all of the banks BA2 and BA3 in the non-volatile memory 13 is completed, the next addresses in the address space in the host 11 are assigned to the banks BA4 and BA5 in the non-volatile memory 13. Furthermore, when the assignment to all of the banks BA4 and BA5 in the non-volatile memory 13 is completed, the next addresses in the address space in the host 11 are assigned to the banks BA6 and BA7 in the non-volatile memory 13. Also for the subsequent addresses, similarly, the address space is assigned to the banks BA8 and BA9, the banks BA10 and BA11, the banks BA12 and BA13, and the banks BA14 and BA15 sequentially toward the higher-level address in the host 11.

In the second conversion example, the setting is so made that four bytes as the erasing unit of the non-volatile memory 13 are included in the access unit of the host 11. Therefore, at the time of writing, data of four bytes equivalent to the erasing unit do not have to be buffered in the memory controller 12.

For example, when a request for writing of the data of eight bytes of the least significant address (0x0000) in the host 11 is issued, data writing to the 0-th row in the bank BA0 in the non-volatile memory 13 is started. Subsequently, data writing to the 0-th row in the bank BA1 is started. In this manner, data are written with interleaving between the banks BA0 and BA1. As the subsequent data writing, similarly, data writing to the first row in the bank BA0, the first row in the bank BA1, the second row in the bank BA0, the second row in the bank BA1, the third row in the bank BA0, the third row in the bank BA1, the fourth row in the bank BA0, and the fourth row in the bank BA1 is sequentially started.

In this manner, the writing can be carried out in such a way that the erasing operation is hidden.

For example, the case in which the time necessary for erasing and writing in the non-volatile memory 13 is equivalent to two clocks of the operating clock will be described below by taking as an example the writing of the data of eight bytes of the least significant address (0x0000) in the host 11.

In this case, as shown by the writing order in FIG. 3, processing of writing data to the 0-th row in the bank BA0 is started in synchronization with the clock CLK0. Subsequently, through bank interleaving, processing of writing data to the 0-th row in the bank BA1 is started in synchronization with the clock CLK1.

Because the time necessary for erasing and writing in the non-volatile memory 13 is equivalent to two clocks of the operating clock, the data writing to the 0-th row in the bank BA0, started in synchronization with the clock CLK0, has been completed at the start of the clock CLK2. Therefore, in synchronization with the clock CLK2, processing of writing data to the first row in the bank BA0 can be started.

For the subsequent data writing, similarly, processing of writing data to the first row in the bank BA1 is started in synchronization with the clock CLK3, processing of writing data to the second row in the bank BA0 is started in synchronization with the clock CLK4, and processing of writing data to the second row in the bank BA1 is started in synchronization with a clock CLK5. Through the repetition of the interleaving in this manner, processing of writing data to the third row in the bank BA1 is started in synchronization with a clock CLK7.

By this bank interleaving, the writing is carried out in such a way that the data erasing operation is hidden from the viewpoint of the host 11.

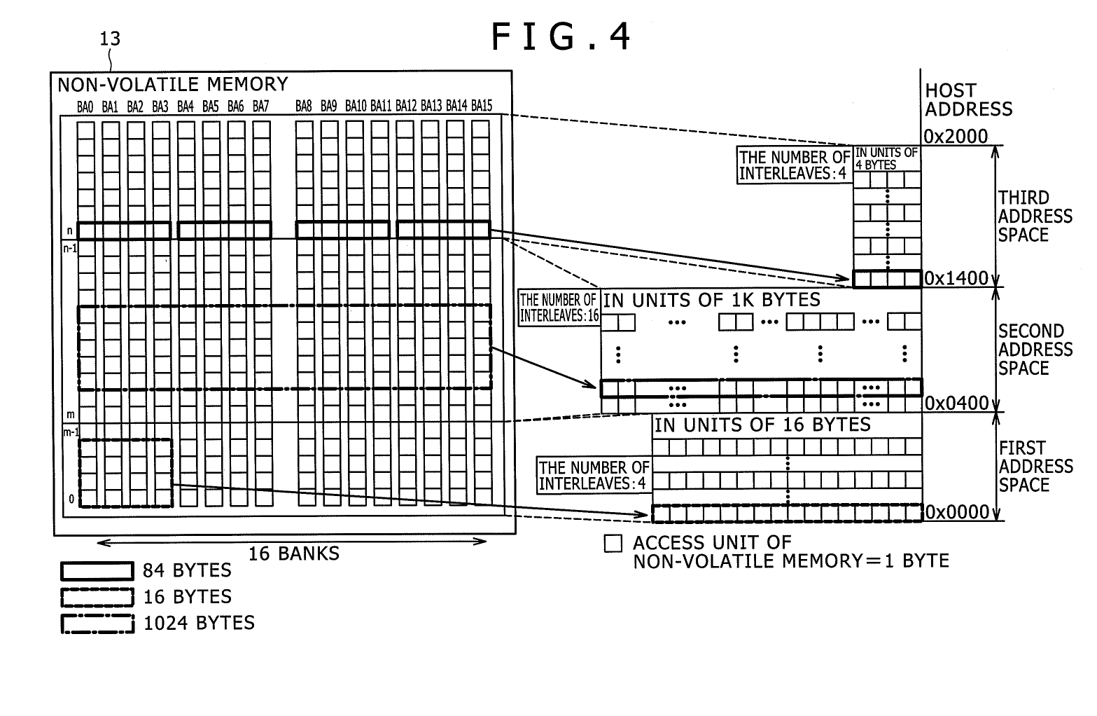

FIG. 4 shows a third conversion example in which the address space in the host 11 is divided and different access units are set for the respective areas. For example, access units different on each address space basis are set when the host 11 executes plural host applications and the access units of the respective host applications are different from each other. Suppose that the non-volatile memory 13 of FIG. 4 includes 16 banks BA0 to BA15 capable of independently operating and allows data writing in units of one byte and data erasing in units of one byte.

In the example of FIG. 4, the address space in the host 11 is divided into three address spaces from a first address space to a third address space. For the first address space (0x0000 to 0x03FF), the access unit from the host 11 and the number of interleaves are set to 16 bytes and four, respectively. For the second address space (0x0400 to 0x13FF), the access unit from the host 11 and the number of interleaves are set to one Kbyte and 16, respectively. For the third address space (0x1400 to 0x1FFF), the access unit from the host 11 and the number of interleaves are set to four bytes and four, respectively.

As above, if the access units are different for each of the address spaces in the host 11, the assignment to the non-volatile memory 13 is so made that all of the banks that can be interleaved are included for each address space. That is, 16 banks BA0 to BA15 are assigned to each of the first to third address spaces. The assignment in this manner can minimize the restrictions on the interleaved banks.

For example, the first address space in the host 11 is assigned to the rows from the 0-th row to the (m−1)-th row in the banks BA0 to BA3 in the non-volatile memory 13 sequentially from the least significant address (0x0000) in the first address space in the host 11 toward the higher-level address. Specifically, 16 bytes of the least significant address are assigned to 16 bytes on the rows from the 0-th row to the third row in the banks BA0 to BA3 (the area surrounded by the heavy line), and 16 bytes of the next address are assigned to 16 bytes on the rows from the fourth row to the seventh row in the banks BA0 to BA3. Also for the subsequent addresses, the first address space in the host 11 is similarly assigned to the banks BA0 to BA3 in the non-volatile memory 13 sequentially toward the higher-level address.

When the assignment to the rows to the (m−1)-th row in the banks BA0 to BA3 in the non-volatile memory 13 is completed, the next addresses in the first address space in the host 11 are assigned to the banks BA4 to BA7 in the non-volatile memory 13. Specifically, 16 bytes of the address subsequent to the address assigned to the (m−1)-th row in the banks BA0 to BA3 in the non-volatile memory 13 are assigned to 16 bytes on the rows from the 0-th row to the third row in the banks BA4 to BA7. Furthermore, 16 bytes of the next address are assigned to 16 bytes on the rows from the fourth row to the seventh row in the banks BA4 to BA7. Also for the subsequent addresses, the first address space in the host 11 is similarly assigned to the banks BA4 to BA7 in the non-volatile memory 13 sequentially toward the higher-level address.

When the assignment to the rows to the (m−1)-th row in the banks BA4 to BA7 in the non-volatile memory 13 is completed, the next addresses in the first address space in the host 11 are assigned to the banks BA8 to BA11 in the non-volatile memory 13. Furthermore, when the assignment to the rows to the (m−1)-th row in the banks BA8 to BA11 in the non-volatile memory 13 is completed, the next addresses in the first address space in the host 11 are assigned to the banks BA12 to BA15 in the non-volatile memory 13.

In this manner, the first address space in the host 11 is assigned to the rows from the 0-th row to the (m−1)-th row in the banks BA0 to BA15 in the non-volatile memory 13.

Next, the second address space in the host 11 will be described below. For example, the second address space in the host 11 is assigned to the rows from the m-th row to the (n−1)-th row in the banks BA0 to BA15 in the non-volatile memory 13 sequentially from the least significant address (0x0400) in the second address space in the host 11 toward the higher-level address. Specifically, 16 bytes of the least significant address are assigned to 16 bytes on the m-th row in the banks BA0 to BA15, and 16 bytes of the next address are assigned to 16 bytes on the (m+1)-th row in the banks BA0 to BA15. Also for the subsequent addresses, the second address space in the host 11 is similarly assigned to the rows to the (n−1)-th row in the banks BA0 to BA15 in the non-volatile memory 13 sequentially toward the higher-level address.

In this manner, the second address space in the host 11 is assigned to the rows from the m-th row to the (n−1)-th row in the banks BA0 to BA15 in the non-volatile memory 13.

Next, the third address space in the host 11 will be described below. For example, the third address space in the host 11 is assigned to the n-th row and the subsequent rows in the banks BA0 to BA3 in the non-volatile memory 13 sequentially from the least significant address (0x1400) in the second address space in the host 11 toward the higher-level address. Specifically, four bytes of the least significant address are assigned to four bytes on the n-th row in the banks BA0 to BA3 (the area surrounded by the heavy line), and four bytes of the next address are assigned to four bytes on the (n+1)-th row in the banks BA0 to BA3. Also for the subsequent addresses, the third address space in the host 11 is similarly assigned to the banks BA0 to BA3 in the non-volatile memory 13 sequentially toward the higher-level address.

When the assignment to the rows to the last row in the banks BA0 to BA3 in the non-volatile memory 13 is completed, the next addresses in the third address space in the host 11 are assigned to the banks BA4 to BA7 in the non-volatile memory 13. Specifically, four bytes of the address subsequent to the last address assigned to the banks BA0 to BA3 in the non-volatile memory 13 are assigned to four bytes on the n-th row in the banks BA4 to BA7. Furthermore, four bytes of the next address are assigned to four bytes on the (n+1)-th row in the banks BA4 to BA7. Also for the subsequent addresses, the third address space in the host 11 is similarly assigned to the banks BA4 to BA7 in the non-volatile memory 13 sequentially toward the higher-level address.

When the assignment to the rows to the last row in the banks BA4 to BA7 in the non-volatile memory 13 is completed, the next addresses in the third address space in the host 11 are assigned to the banks BA8 to BA11 in the non-volatile memory 13. Furthermore, when the assignment to the rows to the last row in the banks BA8 to BA11 in the non-volatile memory 13 is completed, the next addresses in the third address space in the host 11 are assigned to the banks BA12 to BA15 in the non-volatile memory 13.

In this manner, the third address space in the host 11 is assigned to the n-th row and the subsequent rows in the banks BA0 to BA15 in the non-volatile memory 13.

Furthermore, as described above, in the data storing system 10, the host 11 sets the access unit and the number of interleaves to thereby adjust the balance between the erasing time and the writing time, and thereby can prevent the appearance of the erasing time as an overhead.

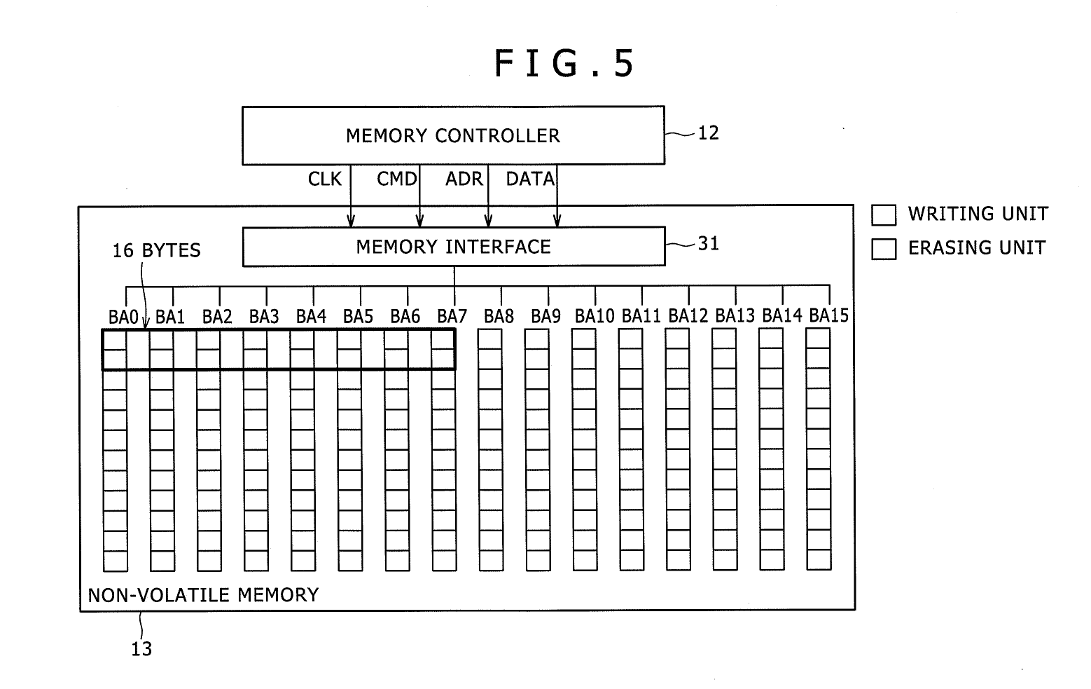

With reference to FIGS. 5 to 16, the balance between the erasing time and the writing time will be described below.

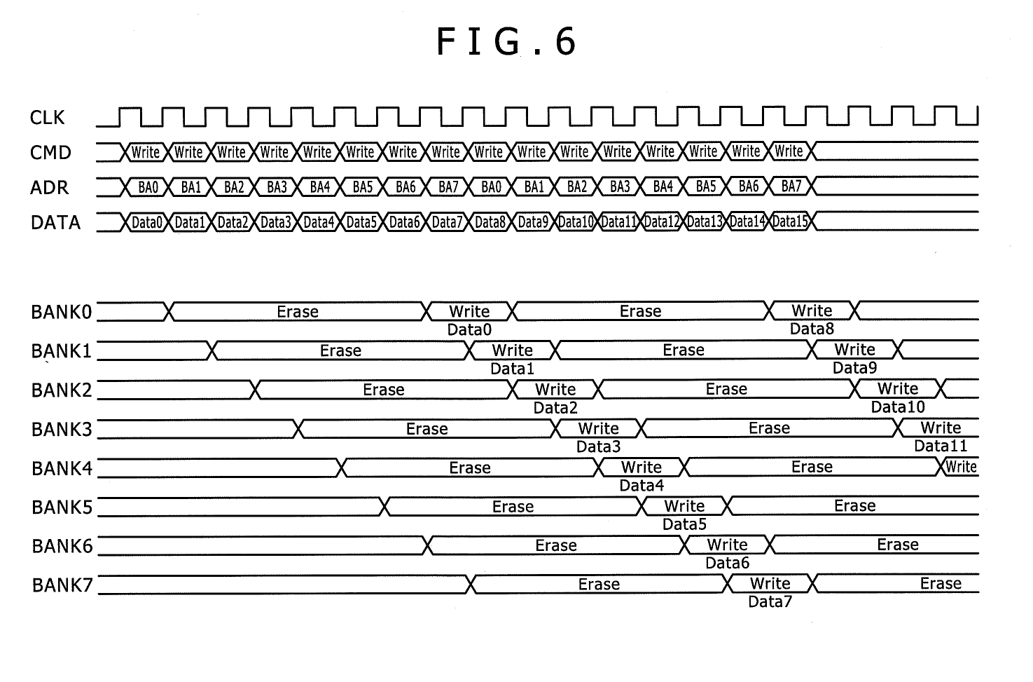

FIG. 5 and FIG. 6 are diagrams for explaining an example in which the data erasing time of the non-volatile memory 13 is longer than the data writing time thereof and the access unit and the number of interleaves are set to 16 bytes and eight, respectively.

FIG. 5 shows the blocks necessary for the explanation among the respective blocks included in the data storing system 10. Suppose that the non-volatile memory 13 of FIG. 5 allows data writing in units of one byte and data erasing in units of one byte. Furthermore, the following signals are supplied from the memory controller 12 to the non-volatile memory 13: a clock signal CLK for synchronization of the processing in the non-volatile memory 13; a command signal CMD indicating data writing and so on; an address signal ADR indicating the address in the non-volatile memory 13 to which data is to be written; and a data signal DATA indicating the data to be written.

For example, when a request for writing of the data of 16 bytes of the least significant address in the host 11 is issued, the data are written to 16 bytes on the O-th row and the first row in the banks BA0 to BA7 in the non-volatile memory 13 (the area surrounded by the heavy line).

At this time, as shown in the upper side of FIG. 6, the address signal ADR (BA0 to BA7) and the data signal DATA (DATA0 to DATA15) as well as the command signal CND (Write) indicating data writing are sequentially supplied in synchronization with the clock signal CLK. Suppose that, in the non-volatile memory 13, the data erasing time is longer than the data writing time, i.e. data erasing takes the time equivalent to six clocks and data writing takes the time equivalent to two clocks for example.

As shown in the lower side of FIG. 6, in the non-volatile memory 13, after the start of writing of data DATA0 to the bank BA0 (a series of processing of erasing and writing), writing of data DATA1 to the bank BA1 is started in synchronization with the next clock. Subsequently, writing of data DATA2 to the bank BA2 is started in synchronization with the next clock. As the subsequent data writing, writing to the bank BA3, the bank BA4, the bank BA5, the bank BA6, and the bank BA7 is sequentially started.

At the timing of the clock subsequent to the clock by which the writing to the bank BA7 is started, the writing of the data DATA0 to the bank BA0 has been completed, and therefore continuously writing of data DATA8 to the bank BA0 is started. At the timing of the next clock, the writing of the data DATA1 to the bank BA1 has been completed, and therefore continuously writing of data DATA9 to the bank BA1 is started. The subsequent data are also sequentially written with bank interleaving.

In this manner, the balance between the time it takes to execute data writing (a series of processing of erasing and writing) and the number of interleaves of the banks is adjusted, and thus the appearance of the erasing time as an overhead is avoided. That is, the erasing time can be hidden from the viewpoint of the host 11, and the access to the non-volatile memory 13 is made continuously (without the occurrence of an interval).

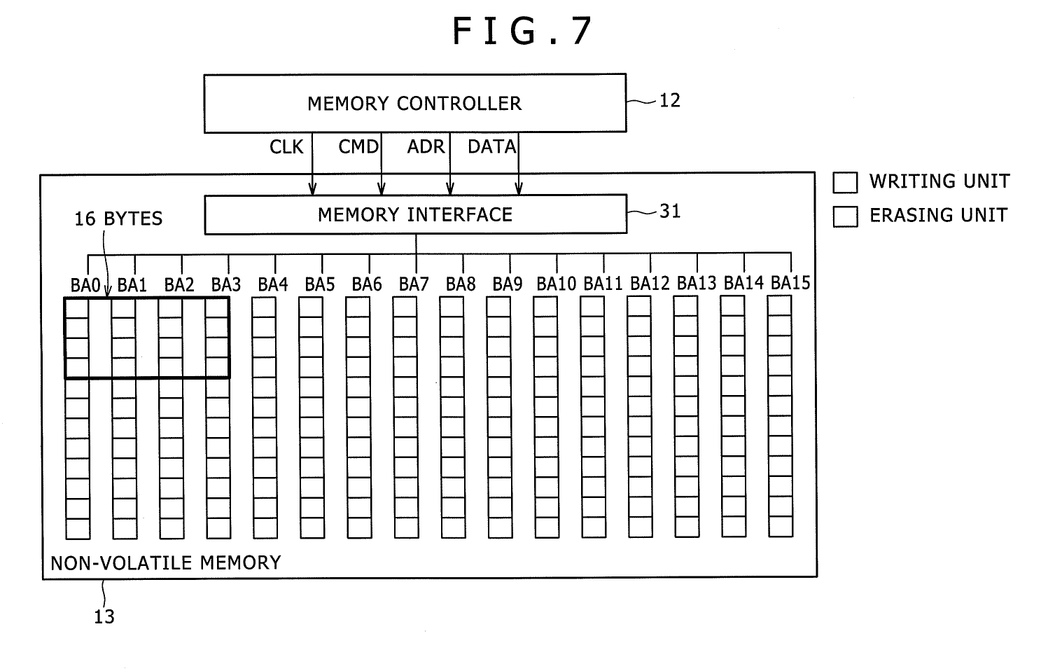

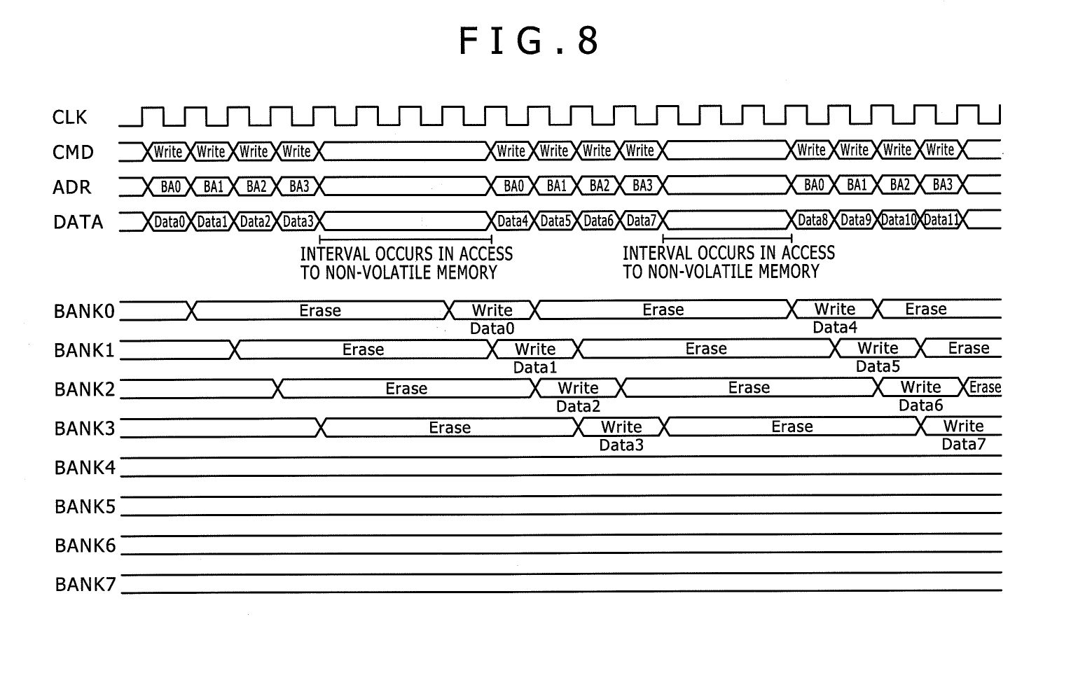

On the other hand, an example in which intervals occur in the access to the non-volatile memory 13 will be described below with reference to FIG. 7 and FIG. 8.

Suppose that, in the non-volatile memory 13 of FIG. 7, the data erasing time is longer than the data writing time, i.e. data erasing takes the time equivalent to six clocks and data writing takes the time equivalent to two clocks for example, similarly to the non-volatile memory 13 of FIG. 5.

If the access unit and the number of interleaves are set to 16 bytes and four, respectively, for such a non-volatile memory 13, intervals occur in the access to the non-volatile memory 13.

If the setting is made in this manner, for example when a request for writing of the data of 16 bytes of the least significant address in the host 11 is issued, the data are written to 16 bytes on the rows from the 0-th row to the third row in the banks BA0 to BA3 in the non-volatile memory 13 (the area surrounded by the heavy line).

At this time, as shown in the upper side of FIG. 8, the command signal CND (Write) indicating data writing, the address signal ADR (BA0 to BA3), and the data signal DATA (DATA0 to DATA15) are sequentially supplied in synchronization with the clock signal CLK.

As shown in the lower side of FIG. 8, in the non-volatile memory 13, after the start of writing of data DATA0 to the bank BA0 (a series of processing of erasing and writing), writing of data DATA1 to the bank BA1 is started in synchronization with the next clock. Subsequently, writing of data DATA2 to the bank BA2 is started in synchronization with the next clock, and writing of data DATA3 to the bank BA3 is started in synchronization with the next clock.

In this example, writing to the bank BA0 is carried out subsequently to writing to the bank BA3 because the number of interleaves is set to four. However, the processing of writing the data DATA0 to the bank BA0 has not been completed at the timing of the clock subsequent to the clock by which the writing of the data DATA3 to the bank BA3 is started. Therefore, in this case, the access to the non-volatile memory 13 needs to be waited until the processing of writing the data to the bank BA0 is ended, and writing of data DATA4 to the bank BA0 is started after the end of the processing of writing the data DATA0 to the bank BA0.

As above, depending on the setting of the access unit and the number of interleaves, intervals occur in the access to the non-volatile memory 13, i.e. the data erasing time appears as an overhead, and thus the performance of the writing processing is lowered. Therefore, the host 11 sets the access unit and the number of interleaves in such a manner as to prevent the occurrence of such intervals, i.e. prevent the appearance of the data erasing time as an overhead.

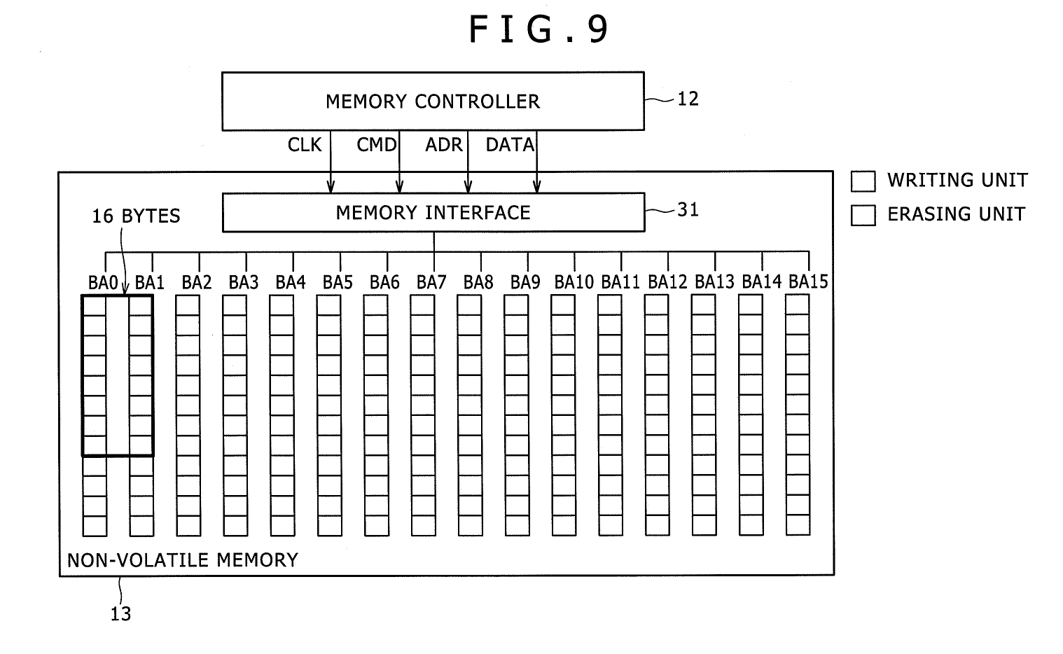

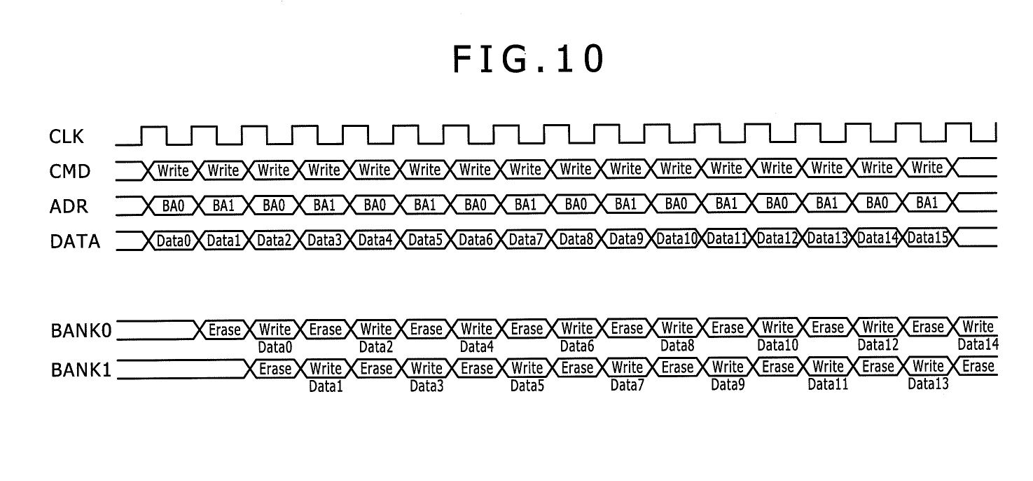

FIG. 9 and FIG. 10 are diagrams for explaining an example in which the data erasing time of the non-volatile memory 13 is equal to the data writing time thereof and the access unit and the number of interleaves are set to 16 bytes and two, respectively.

Suppose that, in the non-volatile memory 13 of FIG. 9, data erasing takes the time equivalent to one clock and data writing takes the time equivalent to one clock. In addition, suppose that the non-volatile memory 13 allows data writing in units of one byte and data erasing in units of one byte.

For example, when a request for writing of the data of 16 bytes of the least significant address in the host 11 is issued, the data are written to 16 bytes on the rows from the 0-th row to the seventh row in the banks BA0 and BA1 in the non-volatile memory 13 (the area surrounded by the heavy line).

At this time, as shown in the upper side of FIG. 10, the address signal ADR (BA0 and BA1, alternately) and the data signal DATA (DATA0 to DATA15) as well as the command signal CMD (Write) indicating data writing are sequentially supplied in synchronization with the clock signal CLK.

As shown in the lower side of FIG. 10, in the non-volatile memory 13, after the start of writing of data DATA0 to the bank BA0 (a series of processing of erasing and writing), writing of data DATA1 to the bank BA1 is started in synchronization with the next clock. At the timing of the clock subsequent to the clock by which the writing to the bank BA1 is started, the writing of the data DATA0 to the bank BA0 has been completed, and therefore continuously writing of data DATA2 to the bank BA0 is started.

The subsequent data DATA3 to DATA15 are also sequentially written with interleaving between the banks BA0 and BA1.

In this manner, the balance between the time it takes to execute data writing (a series of processing of erasing and writing) and the number of interleaves of the banks is adjusted, and thus the appearance of the erasing time as an overhead is avoided.

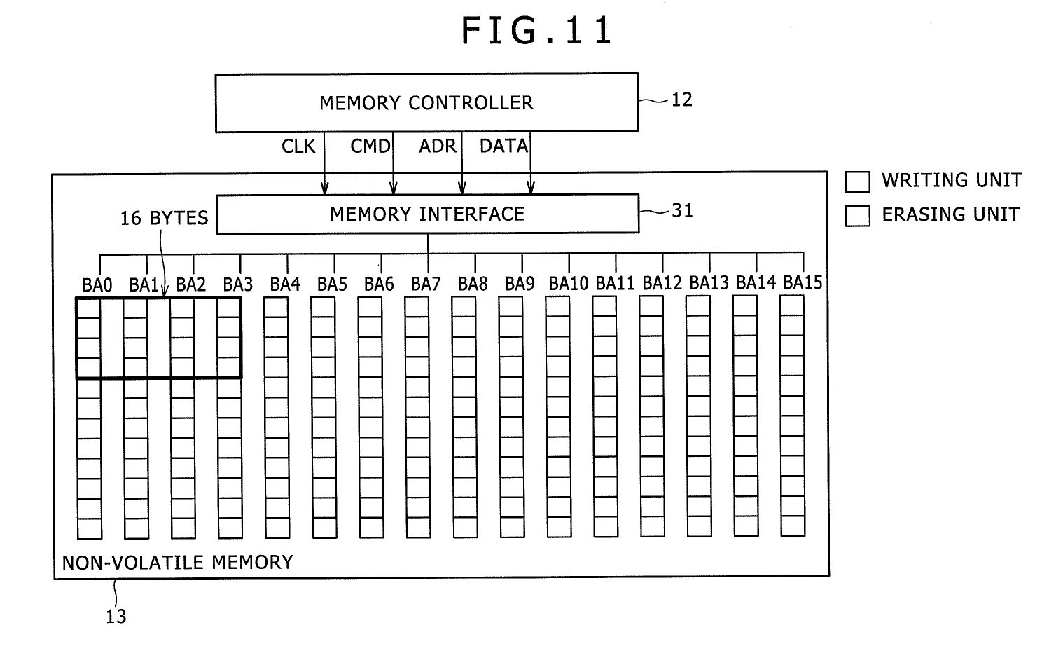

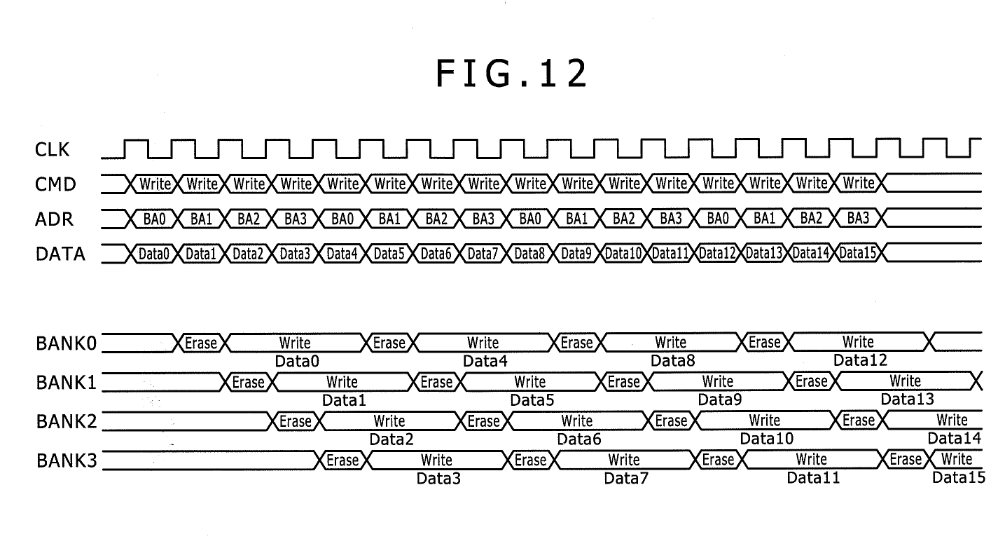

FIG. 11 and FIG. 12 are diagrams for explaining an example in which the data erasing time of the non-volatile memory 13 is shorter than the data writing time thereof and the access unit and the number of interleaves are set to 16 bytes and four, respectively.

Suppose that, in the non-volatile memory 13 of FIG. 11, the data erasing time is shorter than the data writing time, i.e. data erasing takes the time equivalent to one clock and data writing takes the time equivalent to three clocks for example. In addition, suppose that the non-volatile memory 13 allows data writing in units of one byte and data erasing in units of one byte.

For example, when a request for writing of the data of 16 bytes of the least significant address in the host 11 is issued, the data are written to 16 bytes on the rows from the 0-th row to the third row in the banks BA0 and BA3 in the non-volatile memory 13 (the area surrounded by the heavy line).

At this time, as shown in the upper side of FIG. 12, the command signal CMD (Write) indicating data writing, the address signal ADR (BA0 to BA3), and the data signal DATA (DATA0 to DATA15) are sequentially supplied in synchronization with the clock signal CLK.

As shown in the lower side of FIG. 12, in the non-volatile memory 13, after the start of writing of data DATA0 to the bank BA0 (a series of processing of erasing and writing), writing of data DATA1 to the bank BA1 is started in synchronization with the next clock. Subsequently, writing of data DATA2 to the bank BA2 is started in synchronization with the next clock, and writing of data DATA3 to the bank BA3 is started in synchronization with the next clock.

At the timing of the clock subsequent to the clock by which the writing to the bank BA3 is started, the writing of the data DATA0 to the bank BA0 has been completed, and therefore continuously writing of data DATA4 to the bank BA0 is started. At the timing of the next clock, the writing of the data DATA1 to the bank BA1 has been completed, and therefore continuously writing of data DATA5 to the bank BA1 is started. The subsequent data are also sequentially written with bank interleaving.

In this manner, the balance between the time it takes to execute data writing (a series of processing of erasing and writing) and the number of interleaves of the banks is adjusted, and thus the appearance of the erasing time as an overhead is avoided. That is, the erasing time can be hidden from the viewpoint of the host 11, and the access to the non-volatile memory 13 is made continuously (without the occurrence of an interval).

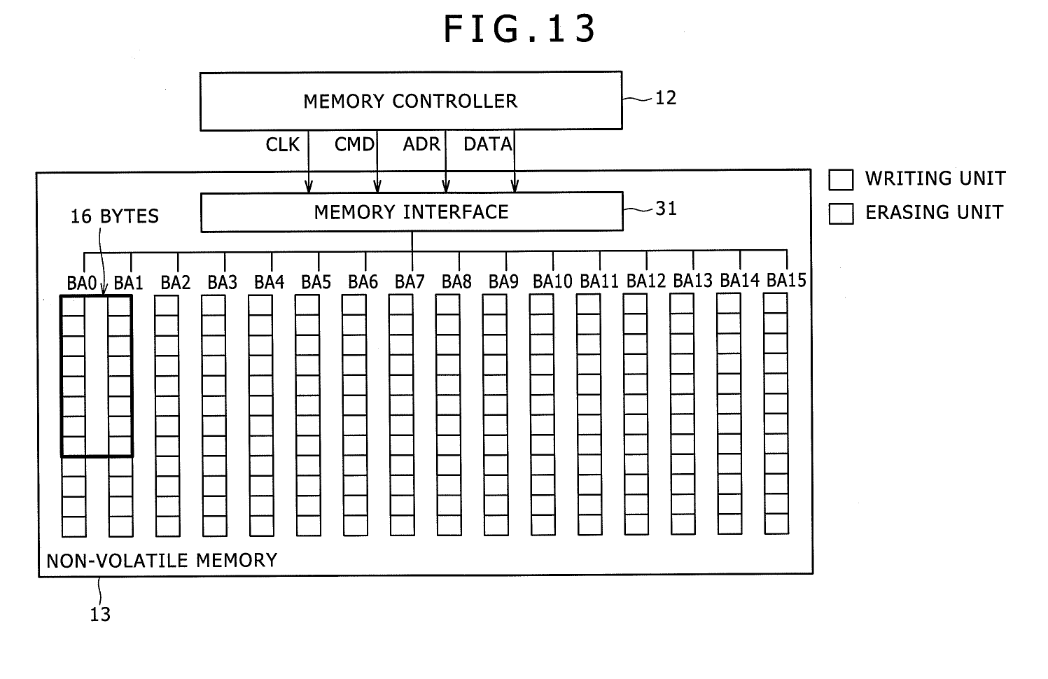

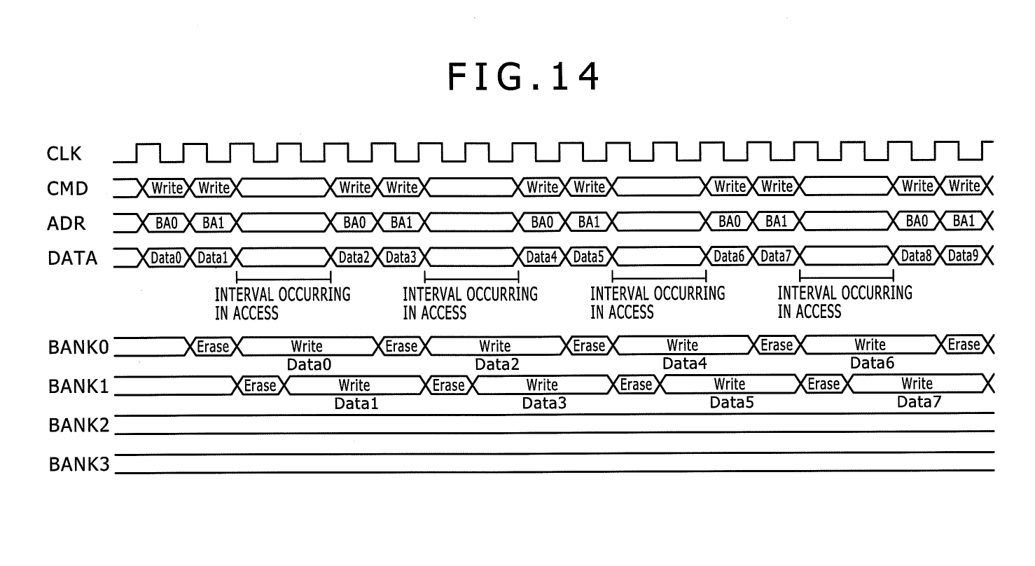

On the other hand, an example in which intervals occur in the access to the non-volatile memory 13 will be described below with reference to FIG. 13 and FIG. 14.

Suppose that, in the non-volatile memory 13 of FIG. 13, the data erasing time is shorter than the data writing time, i.e. data erasing takes the time equivalent to one clock and data writing takes the time equivalent to three clocks for example, similarly to the non-volatile memory 13 of FIG. 11.

If the access unit and the number of interleaves are set to 16 bytes and two, respectively, for such a non-volatile memory 13, intervals occur in the access to the non-volatile memory 13.

If the setting is made in this manner, for example when a request for writing of the data of 16 bytes of the least significant address in the host 11 is issued, the data are written to 16 bytes on the rows from the 0-th row to the seventh row in the banks BA0 and BA1 in the non-volatile memory 13 (the area surrounded by the heavy line).

At this time, as shown in the upper side of FIG. 14, the command signal CND (Write) indicating data writing, the address signal ADR (BA0 and BA1, alternately), and the data signal DATA (DATA0 to DATA15) are sequentially supplied in synchronization with the clock signal CLK.

As shown in the lower side of FIG. 14, in the non-volatile memory 13, after the start of writing of data DATA0 to the bank BA0 (a series of processing of erasing and writing), writing of data DATA1 to the bank BA1 is started in synchronization with the next clock.

In this example, writing to the bank BA0 is carried out subsequently to writing to the bank BA1 because the number of interleaves is set to two. However, the processing of writing the data DATA0 to the bank BA0 has not been completed at the timing of the clock subsequent to the clock by which the writing of the data DATA1 to the bank BA1 is started. Therefore, in this case, the access to the non-volatile memory 13 needs to be waited until the processing of writing the data to the bank BA0 is ended, and writing of data DATA2 to the bank BA0 is started after the end of the processing of writing the data DATA0 to the bank BA0. Furthermore, similarly, an interval occurs in the access also during the period from writing of data DATA3 to the bank BA1 to writing of data DATA4 to the bank BA0 and the period from writing of data DATA5 to the bank BA1 to writing of data DATA6 to the bank BA0.

As above, depending on the setting of the access unit and the number of interleaves, intervals occur in the access to the non-volatile memory 13, i.e. the data erasing time appears as an overhead, and thus the performance of the writing processing is lowered. Therefore, the host 11 sets the access unit and the number of interleaves in such a manner as to prevent the occurrence of such intervals, i.e. prevent the appearance of the data erasing time as an overhead.

In the non-volatile memory 13, the series of processing of erasing and writing data can be executed in units of one byte. Alternatively, this series of processing can be executed in units of plural bytes.

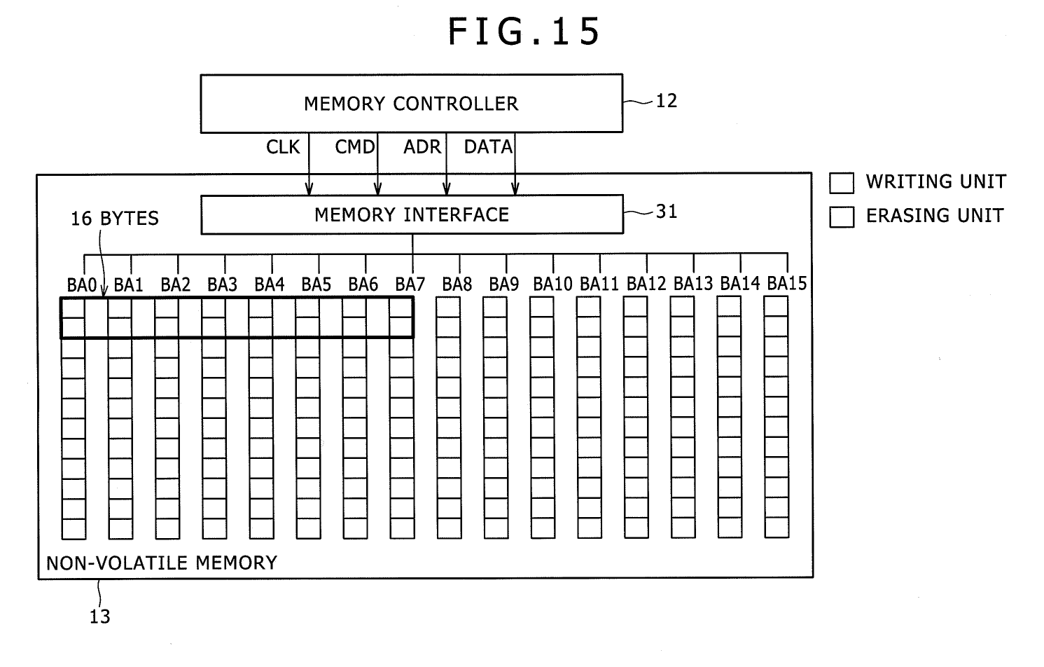

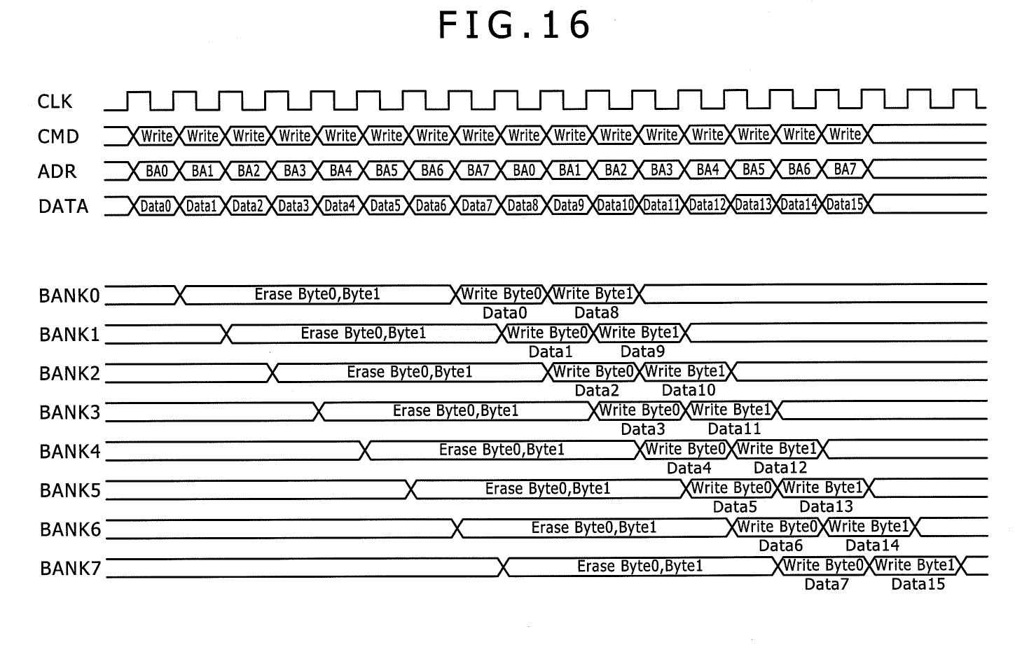

FIG. 15 and FIG. 16 are diagrams for explaining an example in which the series of processing of erasing and writing data is executed in units of two bytes and the access unit and the number of interleaves are set to 16 bytes and eight, respectively. Specifically, because the access unit from the host 11 is set in the memory controller 12 in advance, the memory controller 12 can erase plural bytes included in the access unit in advance at the timing of the start of data writing and can write the data immediately after the writing data are transferred. This feature can further improve the speed of the processing of writing data.

Suppose that, in the non-volatile memory 13 of FIG. 15, erasing of data of two bytes takes the time equivalent to six clocks and writing of data of two bytes takes the time equivalent to four clocks. In addition, suppose that the non-volatile memory 13 allows data writing in units of one byte and data erasing in units of one byte.

For example when a request for writing of the data of 16 bytes of the least significant address in the host 11 is issued, the data are written to 16 bytes on the O-th row and the first row in the banks BA0 to BA7 in the non-volatile memory 13 (the area surrounded by the heavy line).

At this time, as shown in the upper side of FIG. 16, the address signal ADR (BA0 to BA7) and the data signal DATA (DATA0 to DATA15) are supplied together with the command signal CMD (Write) indicating data writing in synchronization with the clock signal CLK.

As shown in the lower side of FIG. 16, in the non-volatile memory 13, writing of data DATA0 and data DATA8 to the 0-th row and the first row in the bank BA0 (a series of processing of erasing and writing) is started. Subsequently, writing of data DATA1 and data DATA9 to the 0-th row and the first row in the bank BA1 is started in synchronization with the next clock. As the subsequent data writing, writing to the 0-th row and the first row in the banks BA3 to BA7 is sequentially started.

Also in the case of executing the series of processing of erasing and writing data in units of plural bytes in this manner, the appearance of the erasing time as an overhead is avoided because the balance between the time it takes to execute the processing and the number of interleaves of the banks is adjusted.

Next, a description will be made below about processing of deciding the number of interleaves, for deciding the number of interleaves used when the memory control is carried out with priority to the processing speed in the data storing system 10.

If priority is given to the processing speed in the data storing system 10, such a number of interleaves that data writing can be carried out while the data erasing operation in the non-volatile memory 13 is hidden from the viewpoint of the host 11 is used as described above with reference to FIGS. 5 to 16.

Such a number of interleaves is decided based on e.g. an erasing time T_{E}, a writing time T_{W}, a data load time T_{DL}, the clock cycle, and the memory I/O bit width. The erasing time T_{E} is the time necessary for erasing per the erasing unit of the non-volatile memory 13. The writing time T_{W} is the time necessary for writing per the writing unit of the non-volatile memory 13. The data load time T_{DL} is the time necessary to transfer, from the memory controller 12 to the non-volatile memory 13, data corresponding to the total size of the data to be written to the banks from the bank of the data writing start to the last bank decided depending on the number of interleaves (the data per the number of interleaves). For example, if data of one byte is transferred per one clock, the data load time T_{DL} is equal to one-clock cycle×the number of interleaves. The clock cycle is the time equivalent to one clock of the clock signal CLK described with reference to FIG. 6 and so on. The memory I/O bit width is the amount of data transferred from the memory controller 12 to the non-volatile memory 13 per the one-clock cycle.

When the non-volatile memory 13 satisfies the condition that the erasing time T_{E}, the writing time T_{W}, and the clock cycle are equal to each other, the host 11 sets the number of interleaves to two. This condition (erasing time T_{E}=writing time T_{W}=clock cycle) is defined as the first decision condition. For example, in the example described with reference to FIG. 9 and FIG. 10, the number of interleaves is set to two because the erasing time T_{E}, the writing time T_{W}, and the clock cycle are equal to each other.

When the non-volatile memory 13 does not satisfy the first decision condition but satisfies the condition that the sum of the erasing time T_{E} and the writing time T_{W} is equal to or shorter than the data load time T_{DL} and the number of interleaves smaller than the number of banks can be set, the host 11 sets the number of interleaves to the value obtained by dividing the sum of the erasing time T_{E} and the writing time T_{W} by the clock cycle (i.e. the number of interleaves=(erasing time T_{E} writing time T_{W})/clock cycle). This condition (erasing time T_{E}+writing time T_{W}≦data load time T_{DL} and the number of interleaves<the number of banks) is defined as the second decision condition, and the formula for deciding the number of interleaves is defined as the first decision formula.

For example, in the example shown in FIG. 5 and FIG. 6, the erasing time T_{E} and the writing time T_{W} are the six-clock cycle and the two-clock cycle, respectively, and therefore the number of interleaves is set to eight (=six-clock cycle+two-clock cycle/clock cycle).

Furthermore, in the example shown in FIG. 11 and FIG. 12, the erasing time T_{E} and the writing time T_{W} are the one-clock cycle and the three-clock cycle, respectively, the number of interleaves is set to four (=one-clock cycle+three-clock cycle/clock cycle).

When the non-volatile memory 13 does not satisfy the first and second decision conditions and the access unit from the host 11 is smaller than the value obtained by multiplying the number of banks and the memory I/O bit width, the host 11 sets the number of interleaves to the value obtained by dividing the access unit from the host 11 by the memory I/O bit width (i.e. the number of interleaves=access unit from the host 11/memory I/O bit width). This condition (access unit from the host 11<the number of banks×memory I/O bit width) is defined as the third decision condition, and the formula for deciding the number of interleaves is defined as the second decision formula.

When the non-volatile memory 13 does not satisfy any of the first to third decision conditions, the host 11 sets the number of interleaves to the number of banks in the non-volatile memory 13.

FIG. 17 is a flowchart for explaining the processing of deciding the number of interleaves. For example, in the data storing system 10, the host 11 executes the processing of deciding the number of interleaves at the time of the first activation.

In a step S1, the host 11 determines whether or not the non-volatile memory 13 satisfies the first decision condition (erasing time T_{E}=writing time T_{W}=clock cycle).

If it is determined by the host 11 in the step S1 that the non-volatile memory 13 satisfies the first decision condition, the processing proceeds to a step S2, where the host 11 sets the number of interleaves to two, so that the processing of deciding the number of interleaves is ended.

On the other hand, if it is determined by the host 11 in the step S1 that the non-volatile memory 13 does not satisfy the first decision condition, the processing proceeds to a step S3. In the step S3, the host 11 determines whether or not the non-volatile memory 13 satisfies the second decision condition (erasing time T_{E}+writing time T_{W}≦data load time T_{DL} and the number of interleaves<the number of banks).

If it is determined by the host 11 in the step S3 that the non-volatile memory 13 satisfies the second decision condition, the processing proceeds to a step S4. In the step S4, the host 11 decides the number of interleaves based on the first decision formula (the number of interleaves=(erasing time T_{E}+writing time T_{W}/clock cycle), so that the processing of deciding the number of interleaves is ended.

On the other hand, if it is determined by the host 11 in the step S3 that the non-volatile memory 13 does not satisfy the second decision condition, the processing proceeds to a step S5. In the step S5, the host 11 determines whether or not the non-volatile memory 13 satisfies the third decision condition (access unit from the host 11<the number of banks×memory I/O bit width).

If it is determined by the host 11 in the step S5 that the non-volatile memory 13 satisfies the third decision condition, the processing proceeds to a step S6. In the step S6, the host 11 decides the number of interleaves based on the second decision formula (the number of interleaves=access unit from the host 11/memory I/O bit width), so that the processing of deciding the number of interleaves is ended.

On the other hand, if it is determined by the host 11 in the step S5 that the non-volatile memory 13 does not satisfy the third decision condition, the processing proceeds to a step S7. In the step S7, the host 11 sets the number of interleaves to the number of banks in the non-volatile memory 13, so that the processing of deciding the number of interleaves is ended.

For example, the access unit from the host 11 is included in the third decision condition used in the determination in the step S5. Therefore, if the access unit from the host 11 has been decided at the time of execution of the processing of deciding the number of interleaves, the determination is made based on the access unit from the host 11. On the other hand, for example, if the access unit from the host 11 has not been decided in the processing of deciding the number of interleaves, the number of interleaves can be decided by executing the processing of the steps S5 to S7 at the start of execution of a host application.

As described above, in the data storing system 10, the host 11 decides the number of interleaves and notifies the memory controller 12 of the number of interleaves, which allows enhancement in the flexibility of the memory control (allows flexible usage). Thus, the memory control with priority to the processing speed or the memory control with priority to suppression of the power consumption is possible. Although the host 11 decides the number of interleaves in the present embodiment, e.g. the memory controller 12 or the non-volatile memory 13 may decide it.

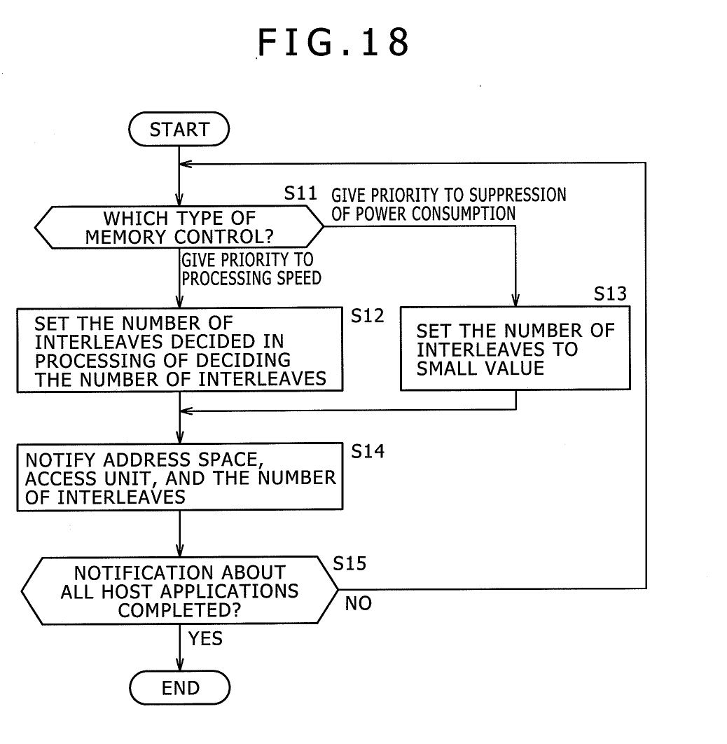

FIG. 18 is a flowchart for explaining processing of making setting for the memory controller 12 in the data storing system 10 of FIG. 1.

For example, this processing is started upon the powering-on of the device incorporating the data storing system 10 and the start of execution of a host application by the host 11. In a step S11, the host 11 determines whether to carry out the memory control with priority to the processing speed or carry out the memory control with priority to suppression of the power consumption depending on the specifications of the host application to be executed, the use environment of the data storing system 10, and so on.

If the host 11 determines to carry out the memory control with priority to the processing speed in the step S11, the processing proceeds to a step S12. In the step S12, the host 11 sets the number of interleaves for the memory control to that decided in the processing of deciding the number of interleaves in FIG. 17.

On the other hand, if the host 11 determines to carry out the memory control with priority to suppression of the power consumption in the step S11, the processing proceeds to a step S13, where the host 11 sets the number of interleaves for the memory control to a small value such as 2.

After the processing of the step S12 or S13, the processing proceeds to a step S14. In the step S14, the host 11 notifies the memory controller 12 of the address space in the host 11, used by the host application to be executed, the access unit suitable for the host application to be executed, and the number of interleaves decided in the step S12 or S13, as setting information.

After the processing of the step S14, the processing proceeds to a step S15, where the host 11 determines whether or not the memory controller 12 has been notified of the address space, the access unit, and the number of interleaves about all of the host applications to be executed. Specifically, if plural host applications are to be executed in the host 11, the address space, the access unit, and the number of interleaves need to be set in the memory controller 12 for each host application as described above with reference to FIG. 4.

Therefore, if it is determined by the host 11 in the step S15 that the memory controller 12 has not been notified of the address space, the access unit, and the number of interleaves about all of the host applications to be executed, i.e. if a host application for which these pieces of information have not been notified to the memory controller 12 is to be executed, the processing returns to the step S11, and thereafter the same processing is repeated for the host application for which the processing of notifying the memory controller 12 of these pieces of information has not been executed.

On the other hand, if it is determined by the host 11 in the step S15 that the memory controller 12 has been notified of the address space, the access unit, and the number of interleaves about all of the host applications to be executed, the processing is ended.

As above, in the data storing system 10, the host 11 can notify the memory controller 12 of the address space, the access unit, and the number of interleaves for each of the host applications to be executed. Due to the notification of the address space, the access unit, and the number of interleaves by the host 11 in this manner, in the data storing system 10, the way of use of the non-volatile memory 13 can be selected depending on the specifications of the host application to be executed, the use environment of the data storing system 10, and so on.

Specifically, in the related-art system employing a non-volatile memory that requires erasing, the host does not notify the memory controller of the number of interleaves in the light of the address space, the access unit, and the erasing time and writing time of the non-volatile memory, and it is impossible to carry out such flexible memory control that the erasing time is hidden in matching with the access unit from the host. In contrast, in the data storing system 10, the host 11 can notify the memory controller 12 of the number of interleaves decided in the light of the address space, the access unit, and the erasing time and writing time of the non-volatile memory for each of the host applications to be executed. Thus, it is possible to carry out the memory control suitable for the specifications of the host application to be executed, the use environment of the data storing system 10, and so on, i.e. the memory control having higher flexibility than that in the related arts. As above, with enhanced flexibility of the memory control compared with the related arts, writing can be carried out in such a way that the erasing operation of the non-volatile memory is hidden.

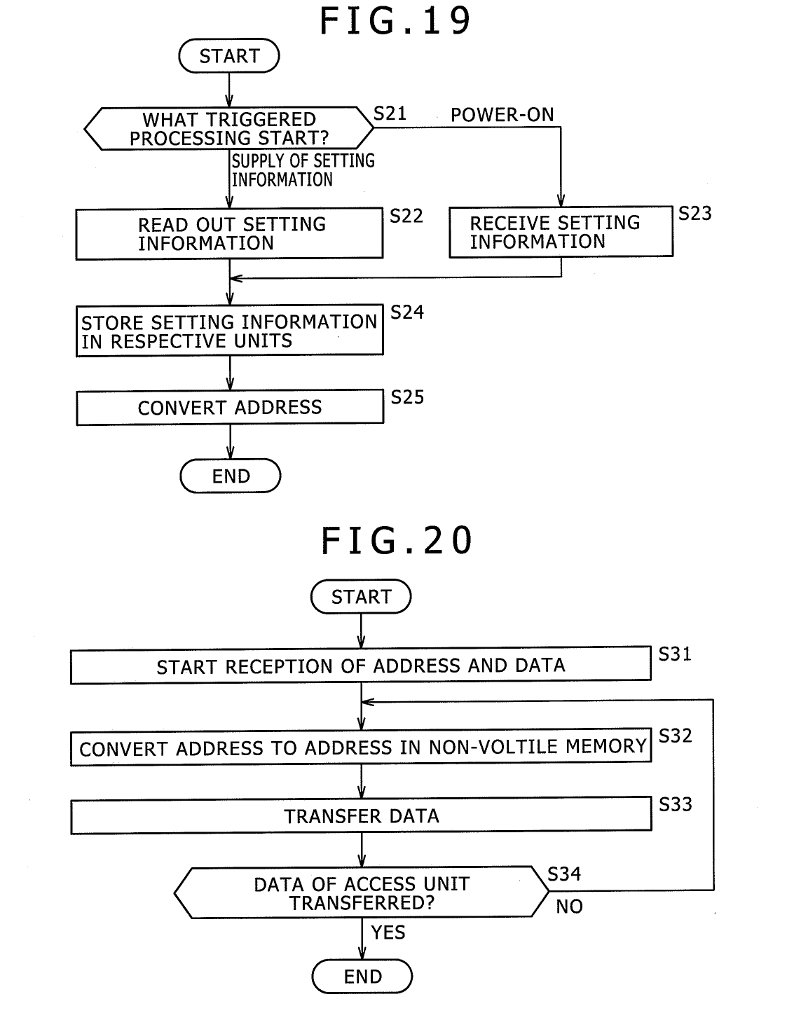

FIG. 19 is a flowchart for explaining processing of converting addresses in the data storing system 10 of FIG. 1.

For example, this processing is started upon the powering-on of the device incorporating the data storing system 10 or supply of setting information from the host 11. In a step S21, the memory control unit 28 in the memory controller 12 determines whether the processing start is triggered by the powering-on or the processing start is triggered by the supply of the setting information from the host 11.

If it is determined by the memory control unit 28 in the step S21 that the processing start is triggered by the powering-on, the processing proceeds to a step S22, where the memory control unit 28 reads out the setting information from the non-volatile memory 13 via the memory interface 22. Specifically, in the data storing system 10, at the time of the system stop, the memory control unit 28 can store, in the non-volatile memory 13, the address space stored in the address space setting unit 25, the access unit stored in the access unit setting unit 26, and the number of interleaves stored in the number-of-interleaves setting unit 27 as the setting information. In the step S22, these pieces of setting information are read out.

On the other hand, if it is determined by the memory control unit 28 in the step S21 that the processing start is triggered by the supply of the setting information from the host 11, the processing proceeds to a step S23, where the memory control unit 28 receives the setting information supplied from the host 11. Specifically, the memory control unit 28 receives the address space, the access unit, and the number of interleaves notified by the host 11 in the step S14 of FIG. 18.

After the processing of the step S22 or S23, the processing proceeds to a step S24, where the memory control unit 28 stores the address space in the register in the address space setting unit 25. In addition, the memory control unit 28 stores the access unit in the register in the access unit setting unit 26 and stores the number of interleaves in the register in the number-of-interleaves setting unit 27.

After the processing of the step S24, the processing proceeds to a step S25, where the address converter 24 converts the address space in the host 11 to addresses in the non-volatile memory 13 based on the address space, the access unit, and the number of interleaves stored in the respective units in the step S24.

For example, if the access unit is set to eight bytes and the number of interleaves is set to four, the address converter 24 assigns the addresses in the host 11 to the banks BA0 to BA15 as described with reference to FIG. 2. Specifically, the address converter 24 assigns the addresses to the banks BA0 to BA3, the banks BA4 to BA7, the banks BA8 to BA11, and the banks BA12 to BA15 sequentially from the lower-level address in the host 11 toward the higher-level address therein.

As above, the address converter 24 converts the address space in the host 11 to the addresses in the non-volatile memory 13 and stores the address conversion table obtained as a result of the conversion in e.g. its own register, so that the processing is ended.

In the above-described manner, in the memory controller 12, the address space in the host 11 can be converted to the addresses in the non-volatile memory 13 based on the address space, the access unit, and the number of interleaves.

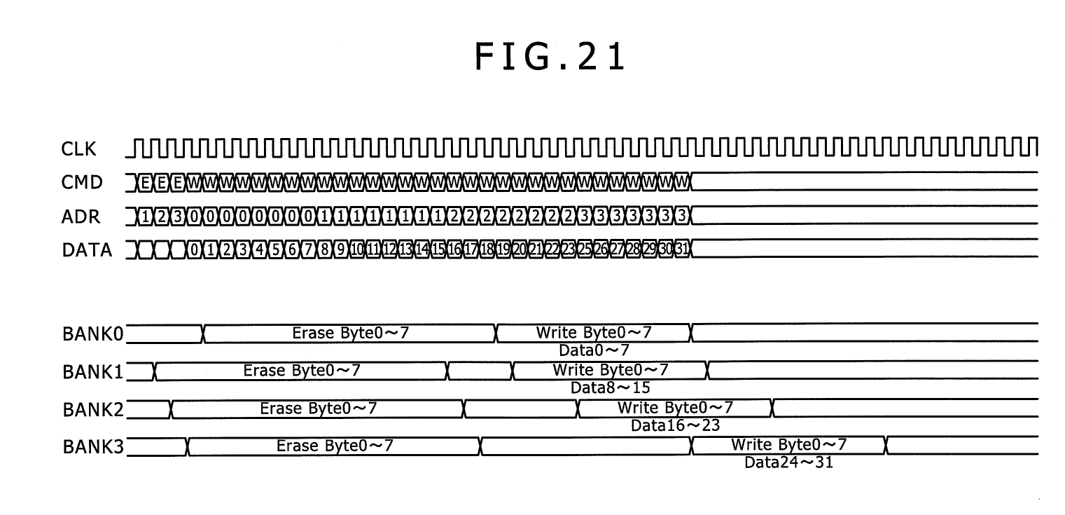

FIG. 20 is a flowchart for explaining processing of writing data of the access unit to the non-volatile memory 13 of FIG. 1.

This processing is started upon the start of transmission of data to be written to the non-volatile memory 13 and the addresses of the data in the host 11 together with the writing command by the host 11. In a step S31, the memory controller 12 starts to receive the addresses and the data. Furthermore, in the memory controller 12, the data buffer 23 buffers the data to be written to the non-volatile memory 13, and the memory control unit 28 acquires the addresses of the data in the host 11.

In a step S32, the memory control unit 28 refers to the address conversion table held by the address converter 24 and converts the addresses in the host 11 acquired in the step S31 to addresses in the non-volatile memory 13. Thereafter, the processing proceeds to a step S33.

At this time, in the address conversion table to which the memory control unit 28 refers, the addresses are so assigned that writing in the writing units is carried out with interleaving of banks in the non-volatile memory 13 and the operation of returning to the row of the next writing unit in the beginning bank when the interleaving is carried out for the same number of banks as the number of interleaves is repeated. Therefore, the addresses in the host 11 are converted to the addresses in the non-volatile memory 13 in such a way that the writing will be carried out with parallel operation with the same number of banks as the number of interleaves.

In the step S33, the memory control unit 28 transmits, to the non-volatile memory 13, the addresses obtained by the conversion in the step S32 and the data that correspond to the addresses obtained by the conversion and are buffered in the data buffer 23 together with the writing command.

After the processing of the step S33, the processing proceeds to a step S34, where the memory control unit 28 determines whether or not data of the access unit have been transferred to the non-volatile memory 13.

If it is determined by the memory control unit 28 in the step S34 that data of the access unit have not been transferred to the non-volatile memory 13, the processing returns to the step S32, and the processing of the steps S32 to S34 is repeated until it is determined that data of the access unit have been transferred. On the other hand, if it is determined by the memory control unit 28 that data of the access unit have been transferred to the non-volatile memory 13, the processing is ended.

As described above, in the data storing system 10, the address space in the host 11, the access unit, and the number of interleaves are set in the memory controller 12. Thus, the addresses in the host 11 are converted to the addresses in the non-volatile memory 13 in such a way that writing will be carried out with parallel operation with the same number of banks as the number of interleaves. Because of this feature, although the non-volatile memory 13 is a memory of such a type that a series of processing of erasing data and then writing data is required, an overhead due to the erasing time can be hidden through writing with interleaving of the banks BA1 to BAN in the non-volatile memory 13. This allows improvement in the speed of processing of writing data, i.e. increase in the speed of the data writing processing.

Specifically, in the memory control in the related arts, the access unit is not taken into consideration, and therefore the erasing time is often longer than the time for caching writing data in the data latch if writing is carried out in various units depending on the application. In this case, an overhead due to the erasing time often significantly appears, and it is often impossible to assign the logical addresses in the host to banks in the non-volatile memory in such a way that the writing speed is enhanced.

In contrast, in the data storing system 10, the memory controller 12 gets to know the address space in the host 11, the access unit, and the number of interleaves. This can prevent the appearance of an overhead and can improve the writing speed.

In addition, because addresses are converted in the memory control unit 28, the host 11 can execute the processing without being conscious of the relationship between addresses in the non-volatile memory 13 and the banks BA1 to BAN that are interleaved.

Moreover, in the case of executing plural host applications whose access units are different from each other, when using one non-volatile memory 13, the host 11 can write data at the optimum processing speed for each of the host applications because the access unit and the number of interleaves are set for each of the address spaces used by the respective host applications.

As described above, the host 11 transfers data in the predetermined access units, and the access unit is stored in the access unit setting unit 26. Furthermore, the host 11 starts the transfer from the data of the lower-level address in the access unit. Therefore, when data of the access unit are transferred from the host 11, the memory control unit 28 can get to know the area in the non-volatile memory 13 in which the data of the access unit are to be written based on the address of the first data of the transferred data and the access unit set in the access unit setting unit 26.

Because of this feature, the memory controller 12 can carry out such memory control that a command (erasing command) instructing the non-volatile memory 13 to erase data therein is transmitted for the area necessary for data writing in advance and the writing to the non-volatile memory 13 is started at the timing when the data to be written to this area are accumulated (hereinafter, this memory control will be accordingly referred to as the erasing-ahead memory control).

At this time, i.e. when the erasing command is supplied from the memory controller 12 before the supply of the writing command, in the non-volatile memory 13, the control unit 32 erases the data in the non-volatile memory 13, and thereafter writes data upon the completion of the data erasing if the writing command is supplied.

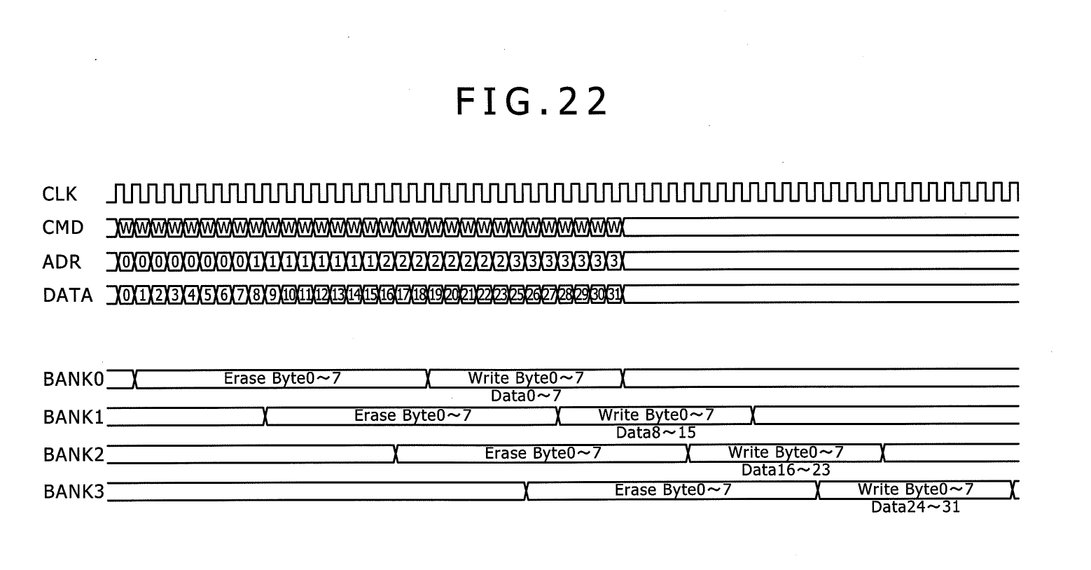

Processing in which the erasing-ahead memory control is carried out and processing in which the erasing-ahead memory control is not carried out will be described below with reference to FIG. 21 and FIG. 22.

FIG. 21 and FIG. 22 are timing charts showing the operation of the memory controller 12 and the non-volatile memory 13 when the access unit and the number of interleaves are set to 32 bytes and four, respectively, and the writing unit and erasing unit of the non-volatile memory 13 are eight bytes.

Upon the start of supply of the data to be written to the non-volatile memory 13 from the host 11, the memory controller 12 causes data erasing in the area corresponding to 32 bytes before the supply of the data from the host 11 to the non-volatile memory 13 because the access unit from the host 11 is 32 bytes. At this time, for the first bank to which the data is to be written, the data is written after data erasing in response to transmission of the command for data writing. Therefore, the memory controller 12 transmits the command signal indicating data erasing to the banks other than the first bank to which the data is to be written. In the present example, the number of interleaves is set to four, and thus the memory controller 12 transmits the command signal indicating data erasing to the banks other than the bank BA0, i.e. to the banks BA1 to BA3.

Specifically, as shown in the upper side of FIG. 21, the memory controller 12 sequentially transmits, in synchronization with the first three clocks, the address signal ADR (1), the address signal ADR (2), and the address signal ADR (3) together with the command signal CND (Erase) indicating data erasing (in FIG. 21, the command signal represented by E). In this manner, the non-volatile memory 13 sequentially starts erasing of eight bytes (Erase Byte 0 to 7), which is equal to the writing unit and the erasing unit, for the banks BA1 to BA3.

Subsequently, in synchronization with the next clock, the memory controller 12 starts transmission of the command signal CMD (Write) indicating data writing (in FIG. 21, the command signal represented by W), and sequentially transmits the address signal ADR (0) and data of eight bytes (Data 0 to 7) to be written to the bank BA0. Thereafter, the memory controller 12 transmits the address signal ADR (1) and data of eight bytes (Data 8 to 15) to be written to the bank BA1, and then transmits the address signal ADR (2) and data of eight bytes (Data 16 to 23) to be written to the bank BA2. Subsequently, the memory controller 12 transmits the address signal ADR (3) and data of eight bytes (Data 24 to 31) to be written to the bank BA3.

On the other hand, in the non-volatile memory 13, the data from the memory controller 12 are temporarily accumulated. When the erasing of the data of eight bytes in the bank BA0, from which the data writing is started, is completed, the writing of the data of eight bytes (Data 0 to 7) to the bank BA0 is started in synchronization with the next clock. At this time, the data of eight bytes to be written to the bank BA1 have also been already accumulated in the non-volatile memory 13. Therefore, the non-volatile memory 13 starts the writing of the data of eight bytes (Data 8 to 15) to the bank BA1 in synchronization with the next clock.

Thereafter, the non-volatile memory 13 waits until the data of eight bytes to be written to the bank BA2 are accumulated. When the data of eight bytes to be written to the bank BA2 are accumulated, the non-volatile memory 13 starts the writing of the data of eight bytes (Data 16 to 23) to the bank BA2 in synchronization with the next clock. Similarly, the non-volatile memory 13 waits until the data of eight bytes to be written to the bank BA3 are accumulated. When the data of eight bytes to be written to the bank BA3 are accumulated, the non-volatile memory 13 starts the writing of the data of eight bytes (Data 24 to 31) to the bank BA3 in synchronization with the next clock.

As above, when the erasing-ahead memory control is carried out, the memory controller 12 can decide the addresses in the non-volatile memory 13 as the erasing-ahead target by converting writing addresses from the host 11 to addresses in the non-volatile memory 13 because the memory controller 12 can get to know the area necessary for data writing based on the access unit from the host 11. Consequently, the memory controller 12 can carry out the data erasing before all of the data of the erasing unit of the non-volatile memory 13 have been collected. Furthermore, in the non-volatile memory 13, for the bank in which the data erasing has been completed, data writing can be carried out upon the collection of all of the data of the writing unit.

On the other hand, if the erasing-ahead memory control is not carried out, i.e. if the host 11 does not notify the memory controller 12 of the access unit and thus the memory controller 12 cannot get to know the area necessary for data writing, the memory controller 12 cannot carry out the data erasing until all of data of the writing unit of the non-volatile memory 13 have been collected. For example, if the data to be written to the non-volatile memory 13 are less than the erasing unit of the non-volatile memory 13, data merging is required. If the erasing is carried out before all of the data of the erasing unit of the non-volatile memory 13 have been collected, even the data that must not be erased are also erased.

Therefore, if the erasing-ahead memory control is not carried out, as shown in FIG. 22, the memory controller 12 sequentially transmits the command signal CMD (Write) indicating data writing, the address signals ADR (0) to ADR (3), and data (Data 0 to 31) in accordance with the data writing order.

Upon the supply of the address signal ADR (0) together with the command signal CMD (Write), the non-volatile memory 13 starts data erasing in the bank BA0 and writes the data (Data 0 to 7) after the erasing. Similarly, upon the supply of the address signal ADR (1) together with the command signal CMD (Write), data erasing in the bank BA1 is started and the data (Data 8 to 15) are written after the erasing. Thereafter, upon the supply of the address signal ADR (2) together with the command signal CMD (Write), data erasing in the bank BA2 is started and the data (Data 16 to 23) are written after the erasing. Thereafter, upon the supply of the address signal ADR (3) together with the command signal CMD (Write), data erasing in the bank BA3 is started and the data (Data 24 to 31) are written after the erasing.

As is apparent from comparison between FIG. 21 and FIG. 22, the data writing can be completed earlier (in the examples of FIG. 21 and FIG. 22, earlier by eight clocks) by the processing in which the erasing-ahead memory control is carried out than by the processing in which the erasing-ahead memory control is not carried out.

Furthermore, when the erasing-ahead memory control is carried out, the memory controller 12 can transfer data to the non-volatile memory 13 during erasing in the non-volatile memory 13. Thus, the time necessary for the processing of writing to the non-volatile memory 13 can be shortened to a higher degree when the time necessary for the erasing per the erasing unit of the non-volatile memory 13 is longer and the writing unit of the non-volatile memory 13 is larger.

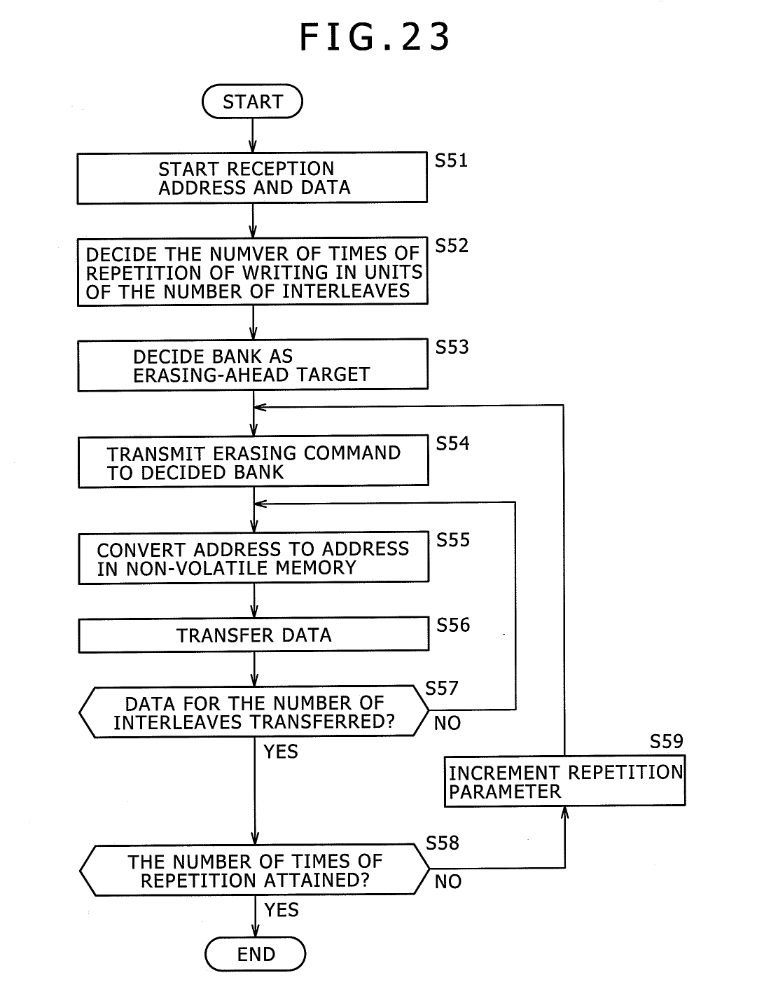

FIG. 23 is a flowchart for explaining processing of writing data of the access unit to the non-volatile memory 13 of FIG. 1 by carrying out the erasing-ahead memory control.

This processing is started upon the start of transmission of data to be written to the non-volatile memory 13 and the addresses of the data in the host 11 together with the writing command by the host 11. In a step S51, the memory controller 12 starts reception of the addresses and the data. In the memory controller 12, the data buffer 23 buffers the data to be written to the non-volatile memory 13, and the memory control unit 28 acquires the addresses of the data in the host 11.

In a step S52, the memory control unit 28 decides the necessary number of times of the repetition of writing in units of the number of interleaves for writing the data of the access unit and sets a repetition parameter for counting the number of times of the repetition to zero. Specifically, if the access unit from the host 11 is larger than the value obtained by multiplying the number of interleaves and the writing unit, writing to the banks from the bank from which the data writing is started to the last bank dependent on the number of interleaves is repeated plural times. The memory control unit 28 obtains the number of times of this repetition.

For example, if the writing unit of the non-volatile memory 13 is A (Bytes), the number of interleaves is B, and the access unit from the host 11 is C (Bytes), the number of times of the repetition can be obtained from C/A×B. Specifically, if the writing unit of the non-volatile memory 13 is eight (Bytes), the number of interleaves is four, and the access unit from the host 11 is 64 (Bytes), two is obtained as the number of times of the repetition.

After the processing of the step S52, the processing proceeds to a step S53, where the memory control unit 28 decides the bank to which the erasing command will be transmitted in advance for carrying out data erasing, among the banks as the data writing target. For example, the memory control unit 28 gets to know the plural banks necessary for writing the data of the access unit based on the address from which the data writing is started (the address obtained by converting the address of the first data transmitted from the host 11 to the address in the non-volatile memory 13) and the access unit set in the access unit setting unit 26. Subsequently, the memory control unit 28 decides, among these banks, the second and subsequent banks to which data are to be written as the erasing-ahead target bank.

After the processing of the step S53, the processing proceeds to a step S54, where the memory control unit 28 transmits the erasing command to the banks decided as the erasing-ahead target in the step S53 in the data writing order. Thereafter, the processing proceeds to a step S55.

In the step S55, the memory control unit 28 refers to the address conversion table held by the address converter 24 and converts the addresses in the host 11 acquired in the step S51 to addresses in the non-volatile memory 13, so that the processing proceeds to a step S56.

In the step S56, the memory control unit 28 transmits, to the non-volatile memory 13, the addresses obtained by the conversion in the step S55 and the data that correspond to the addresses obtained by the conversion and are buffered in the data buffer 23 together with the writing command.

After the processing of the step S56, the processing proceeds to a step S57, where the memory control unit 28 determines whether or not data for the number of interleaves have been transferred to the non-volatile memory 13.

For example, the data for the number of interleaves refers to the amount of data in the writing as one cycle of the repletion of writing in the writing units for the banks from the bank from which the data writing is started to the last bank dependent on the number of interleaves (i.e. the number of interleaves×writing unit of the non-volatile memory 13).

If it is determined by the memory control unit 28 in the step S57 that the data for the number of interleaves have not been transferred to the non-volatile memory 13, the processing returns to the step S55 and the processing is repeated until it is determined that the data for the number of interleaves have been transferred to the non-volatile memory 13. On the other hand, if it is determined by the memory control unit 28 in the step S57 that the data for the number of interleaves have been transferred to the non-volatile memory 13, the processing proceeds to a step S58.

In the step S58, the memory control unit 28 determines whether or not the writing in units of the number of interleaves has been repeated the number of times of the repetition decided in the step S52. For example, if the repetition parameter, set to zero in the step S52, has attained the number of times of the repetition, it is determined by the memory control unit 28 that the writing in units of the number of interleaves has been repeated the number of times of the repetition. On the other hand, if the repetition parameter, set to zero in the step S52, is smaller than the number of times of the repetition, it is determined by the memory control unit 28 that the writing in units of the number of interleaves has not been repeated the number of times of the repetition.

If it is determined by the memory control unit 28 in the step S58 that the writing in units of the number of interleaves has not been repeated the number of times of the repetition, the processing proceeds to a step S59, where the memory control unit 28 increments the repetition parameter. Thereafter, the processing returns to the step S54, so that the same processing is repeated subsequently.

On the other hand, if it is determined by the memory control unit 28 in the step S58 that the writing in units of the number of interleaves has been repeated the number of times of the repetition, the data of the access unit have been transferred to the non-volatile memory 13, so that the processing is ended.

As described above, in the data storing system 10, the memory controller 12 knows the area necessary for data writing based on the access unit. This allows such memory control that the erasing command is transmitted for the area necessary for the data writing in advance and the writing to the non-volatile memory 13 is started at the timing when the data to be written to this area are accumulated. This feature can further increase the speed of the data writing processing.

The present invention can be applied not only to the system in which the memory controller 12 and the non-volatile memory 13 are independently configured as shown in FIG. 1 but also to a non-volatile memory having the functions of the memory controller.

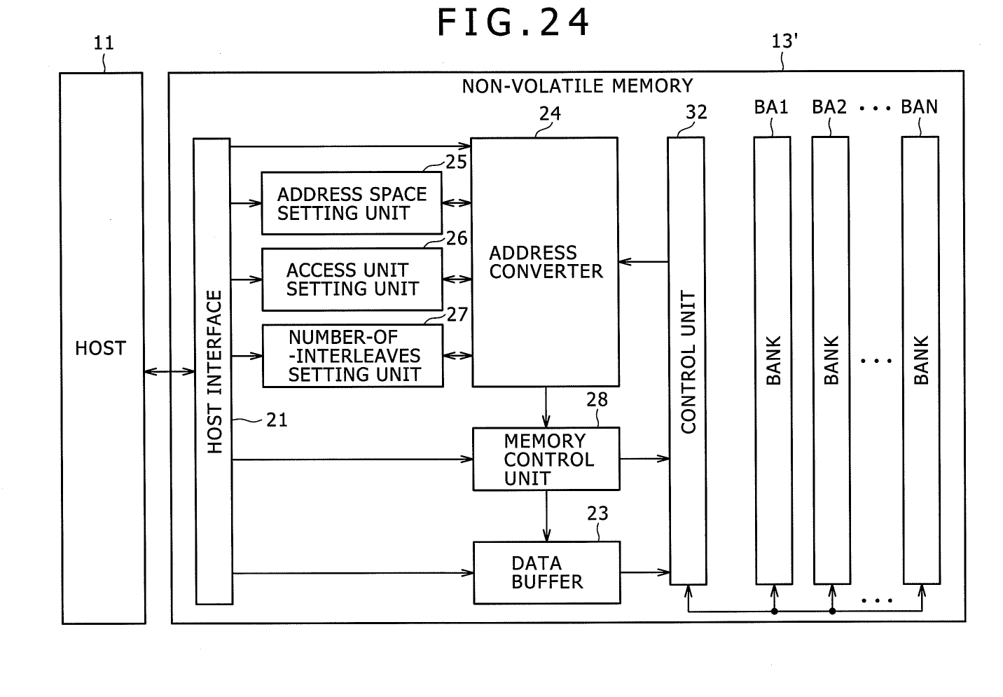

Specifically, FIG. 24 is a block diagram showing a configuration example of a data storing system according to another embodiment of the present invention.

In FIG. 24, the same blocks as those in the data storing system 10 of FIG. 1 are given the same numerals and the description thereof is accordingly omitted.

Specifically, the embodiment shown in FIG. 24 is different from the non-volatile memory 13 of FIG. 1 in that the host interface 21, the data buffer 23, the address converter 24, the address space setting unit 25, the access unit setting unit 26, the number-of-interleaves setting unit 27, and the memory control unit 28 are incorporated in a non-volatile memory 13′.

Also in the data storing system in which the non-volatile memory 13′ including the functions of the memory controller 12 is used in this manner, similarly to the data storing system 10 of FIG. 1, the host 11 can set the access unit and the number of interleaves for the non-volatile memory 13′. Furthermore, data writing can be carried out in such a way that the data erasing time can be hidden from the viewpoint of the host 11.

The above-described series of processing can be executed by hardware or alternatively can be executed by software. In the case of executing the series of processing by software, the program for constructing the software is installed in e.g. a computer incorporated in dedicated hardware or a general-purpose computer that can execute various kinds of functions through installation of various kinds of programs therein.

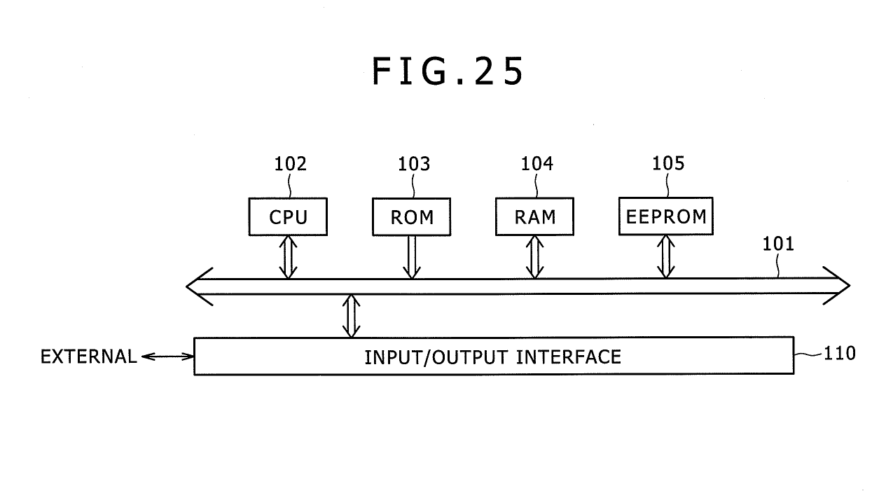

FIG. 25 is a block diagram showing a configuration example of the hardware of a computer (microcomputer) that executes the above-described series of processing based on a program.

The program can be recorded (installed) in advance in an electrically erasable programmable read-only memory (EEPROM) 105 or a read only memory (ROM) 103 serving as a recording medium included in the computer.

Alternatively, the program can be provided in such a manner as to be temporarily or permanently stored (recorded) in a removable recording medium such as a flexible disc, a compact disc read only memory (CD-ROM), a magneto optical (MO) disc, a digital versatile disc (DVD), a magnetic disc, or a semiconductor memory.

Instead of being installed in the computer from the above-described removable recording medium, the program can be transferred to the computer via a wired or wireless network. In the computer, the thus transferred program can be received by an input/output interface 110 and be installed in the incorporated EEPROM 105.

In the computer, a central processing unit (CPU) (or a digital signal processor (DSP)) 102, the ROM 103, a random access memory (RAM) 104, the EEPROM 105, and the input/output interface 110 are connected to each other via a bus 101.

The CPU 102 loads the program stored in the ROM 103 or the EEPROM 105 into the RAM 104 and executes the program. In this manner, the CPU 102 executes processing in accordance with the above-described flowcharts or processing based on the configurations of the above-described block diagrams. Data exchange with the external is performed via the input/output interface 110.

The program executed by the computer may be a program that is processed in a time-series manner along the order described in the present specification, or may be a program that is processed in parallel or at the necessary timing such as when calling is made. That is, the respective kinds of processing described with reference to the above-described flowcharts do not necessarily need to be executed in a time-series manner along the orders described as the flowcharts but encompass also processing that is executed in parallel or individually (e.g. parallel processing or processing by objects). In addition, the program may be processed by one CPU, or alternatively may be processed in a distributed manner by plural CPUs.

The embodiments of the present invention are not limited to above-described embodiments but various changes can be incorporated therein without departing from the scope of the present invention.

The present application contains subject matter related to that disclosed in Japanese Priority Patent Application JP 2009-113414 filed in the Japan Patent Office on May 8, 2009, the entire content of which is hereby incorporated by reference.

What is claimed is:

1. A data storing system comprising:
a non-volatile memory configured to have a plurality of memory blocks each capable of independently operating and allow random access to each of addresses;
control means for controlling writing of data to the non-volatile memory; and
executing means for executing a predetermined application, wherein
the executing means decides the number of interleaves indicating the number of memory blocks operated in parallel among the plurality of memory blocks, and
the executing means notifies the control means of the decided number of interleaves.

2. The data storing system according to claim 1, wherein
the executing means further notifies the control means of an address space in the executing means used by the application and an access unit set in the application.

3. The data storing system according to claim 2, wherein
the control means has
setting means for saving the address space, the access unit, and the number of interleaves notified from the executing means, and
assigning means for assigning the address space in the executing means to addresses in the non-volatile memory based on the address space, the access unit, and the number of interleaves saved in the setting means.

4. The data storing system according to claim 3, wherein
the control means ensures, in the non-volatile memory, an area for storing the address space, the access unit, and the number of interleaves saved in the setting means, and makes the non-volatile memory store the address space, the access unit, and the number of interleaves at the time of system stop.

5. The data storing system according to claim 4, wherein
the control means reads out the address space, the access unit, and the number of interleaves stored in the non-volatile memory and makes the setting means save the address space, the access unit, and the number of interleaves at the time of system activation.

6. The data storing system according to claim 1, wherein
in writing of data to a predetermined address in the non-volatile memory, the control means transmits, to the non-volatile memory, a command to carry out a series of operation of erasing data of the predetermined address and subsequently writing data.

7. The data storing system according to claim 3, wherein
the control means has
converting means for, in response to supply of a writing command instructing the non-volatile memory to write data from the executing means, referring to assignment to the addresses in the non-volatile memory by the assigning means and converting an address of the data specified by the writing command in the executing means to an address in the non-volatile memory, and
writing control means for transferring the address obtained by conversion by the converting means and the data from the executing means to the non-volatile memory and making the non-volatile memory write the data.

8. The data storing system according to claim 2, wherein
when executing a plurality of the applications, the executing means notifies the access unit and the number of interleaves for each of address spaces used by the applications.

9. The data storing system according to claim 8, wherein
the control means has
setting means for saving a plurality of the address spaces notified from the executing means and the access units and the numbers of interleaves each corresponding to a respective one of the address spaces, and
assigning means for assigning each of the address spaces in the executing means to addresses in the non-volatile memory in such a way that all of the memory blocks in the non-volatile memory are assigned to the address spaces based on the access units and the numbers of interleaves that are saved in the setting means and each correspond to a respective one of the address spaces.

10. A data storing method of a data storing system including
a non-volatile memory that has a plurality of memory blocks each capable of independently operating and allows random access to each of addresses,
control means for controlling writing of data to the non-volatile memory, and
executing means for executing a predetermined application, the data storing method comprising the steps of:
deciding the number of interleaves indicating the number of memory blocks operated in parallel among the plurality of memory blocks; and
notifying the control means of the decided number of interleaves.

11. An executing device that executes a predetermined application, comprising:
deciding means for deciding the number of interleaves indicating the number of memory blocks operated in parallel among a plurality of memory blocks each capable of independently operating in a non-volatile memory that has the plurality of memory blocks and allows random access to each of addresses; and
notifying means for notifying the decided number of interleaves to control means that controls writing of data to the non-volatile memory.

12. The executing device according to claim 11, wherein
the notifying means further notifies the control means of an address space in the executing device used by the application and an access unit set in the application.

13. A control method of an executing device that executes a predetermined application, the control method comprising the steps of:
deciding the number of interleaves indicating the number of memory blocks operated in parallel among a plurality of memory blocks each capable of independently operating in a non-volatile memory that has the plurality of memory blocks and allows random access to each of addresses; and
notifying the decided number of interleaves to control means that controls writing of data to the non-volatile memory.

14. A control device that controls writing of data to a non-volatile memory that has a plurality of memory blocks each capable of independently operating and allows random access to each of addresses, the control device comprising:
setting means for saving an address space used by a predetermined application executed by executing means, an access unit set in the application, and the number of interleaves indicating the number of memory blocks operated in parallel among the plurality of memory blocks, the address space, the access unit, and the number of interleaves being notified from the executing means; and
assigning means for assigning the address space in the executing means to addresses in the non-volatile memory based on the address space, the access unit, and the number of interleaves saved in the setting means.

15. A control method of a control device that controls writing of data to a non-volatile memory that has a plurality of memory blocks each capable of independently operating and allows random access to each of addresses, the control method comprising the steps of:
saving an address space used by a predetermined application executed by executing means, an access unit set in the application, and the number of interleaves indicating the number of memory blocks operated in parallel among the plurality of memory blocks, the address space, the access unit, and the number of interleaves being notified from the executing means; and
assigning the address space in the executing means to addresses in the non-volatile memory based on the address space, the access unit, and the number of interleaves that are saved.

16. An executing device that executes a predetermined application, comprising:
a deciding unit configured to decide the number of interleaves indicating the number of memory blocks operated in parallel among a plurality of memory blocks each capable of independently operating in a non-volatile memory that has the plurality of memory blocks and allows random access to each of addresses; and
a notifying unit configured to notify the decided number of interleaves to a controller that controls writing of data to the non-volatile memory.

17. A control device that controls writing of data to a non-volatile memory that has a plurality of memory blocks each capable of independently operating and allows random access to each of addresses, the control device comprising:
a setting unit configured to save an address space used by a predetermined application executed by an executing unit, an access unit set in the application, and the number of interleaves indicating the number of memory blocks operated in parallel among the plurality of memory blocks, the address space, the access unit, and the number of interleaves being notified from the executing unit; and
an assigning unit configured to assign the address space in the executing unit to addresses in the non-volatile memory based on the address space, the access unit, and the number of interleaves saved in the setting unit.
